(19) United States
(12) Patent Application Publication
(10) Pub. No.: US 2025/0190768 A1
(43) Pub. Date: Jun. 12, 2025

(54) GENERATIVE NEURAL APPLICATION ENGINE

(71) Applicant: Microsoft Technology Licensing, LLC, Redmond, WA (US)

(72) Inventors: Martin GRAYSON, Cambridge (GB); Cecily MORRISON, Cambridge (GB); Yilin WEN, Cambridge (GB); Katja HOFMANN, Cambridge (GB); Sam DEVLIN, Cambridge (GB); Anssi KANERVISTO, Cambridge (GB); Shan Zheng TAN, Cambridge (GB)

(73) Assignee: Microsoft Technology Licensing, LLC, Redmond, WA (US)

(21) Appl. No.: 18/398,724

(22) Filed: Dec. 28, 2023

Related U.S. Application Data
(60) Provisional application No. 63/607,256, filed on Dec. 7, 2023.

(51) Int. Cl. G06N 3/0475; A63F 13/60; G06F 3/0484

(52) U.S. Cl. CPC G06N 3/0475; G06F 3/0484; A63F 13/60

(57) ABSTRACT

Various example user interface (UI) mechanisms are described herein, each of which enables a user to efficiently and intuitively manipulate a trained generative model at runtime. Among other things, the described techniques have applications in the field of game design or application design more generally, enabling a game or application developer to easily generate extended application (e.g., gameplay) sequences. Other applications include guided image or audio synthesis, or other forms of guided output generation (e.g., synthesized code, simulated or actual industrial outputs, engineering data, cybersecurity data etc.).

### BACKGROUND

Traditionally, interactive applications such as video games were developed by hand-coding the entire application. Subsequently, supporting technologies such as application engines were developed. An application engine allows a developer to develop their own code for part of their application while offloading certain functions, such as graphics rendering or physics simulations, to the application engine. However, while application engines have greatly simplified application development, coding of complex interactive applications is still a very intensive process.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various example user interface (UI) mechanisms (graphical and non-graphical) are described herein, each of which enables a user to efficiently and intuitively manipulate a trained generative model at runtime. Among other things, the described techniques have applications in the field of game design more generally, enabling a game developer to easily generate extended gameplay sequences, such as a sequence of game frames where each game frame comprises a game image and a game controller state. Other applications include guided image or audio synthesis; for example, generating synthetic image sequences (e.g. videos) or sequences of audio data (e.g. in a music generation tool). The techniques can be extended to other use cases, such as application design more generally. In some embodiments, one or more graphical user interface (GUI) mechanisms are provided for manipulating input sequences to a trained generative model. In some embodiments, a trained generative model is controlled based on user-defined controller states. For example, such states could be defined using a hardware controller (such as a game controller in a game design context) to generate elements of input sequences to a generative model. More generally, the described techniques can be applied to any generated outputs, e.g. to create or manipulate branches of generative model output (e.g., synthesized code, simulated or actual industrial outputs, engineering data, cybersecurity data, such as simulated cyberattack outputs used to identify and mitigate security issues with systems though appropriate security mitigation actions).

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1A illustrates an example overall workflow for training and employing a machine learning model to implement application engine functionality, consistent with some implementations of the present concepts.

FIG. 1B illustrates an example decoder-based architecture for a generative model, consistent with some implementations of the present concepts.

FIGS. 2A-2D illustrate an example training sequence obtained by executing a first interactive application, consistent with some implementations of the present concepts.

FIGS. 3A-3D illustrate an example training sequence obtained by executing a second interactive application, consistent with some implementations of the present concepts.

FIG. 4A illustrates an example of a seed image that can be input to a trained machine learning model, consistent with some implementations of the present concepts.

FIGS. 4B-4D illustrate an example sequence output by a trained machine learning model, consistent with some implementations of the present concepts.

FIG. 5 illustrates an example of an encoder/decoder and transformer architecture that can be employed as machine learning models, consistent with some implementations of the present concepts.

FIGS. 6A-6C, 7A-7C, 8A-8C, and 9 illustrate experimental results that were obtained using specific implementations of the present concepts.

FIG. 10 illustrates an example system, consistent with some implementations of the present concepts.

FIG. 11A shows a schematic block diagram of a first example probabilistic neural dreaming model;

FIG. 11B shows a schematic block diagram of a second example probabilistic neural dreaming model;

FIG. 12 shows a schematic function block diagram of a frame generation system;

FIG. 13 shows a schematic illustration of a branching view within a frame generation interface;

FIG. 14 shows a schematic illustration of a frame manipulation view within a frame generation interface;

FIG. 15 schematically illustrates a frame generation mechanism based on user control inputs;

FIG. 16 illustrates a method for training a machine learning model to predict application outputs and inputs, consistent with some implementations of the present concepts.

FIG. 17 illustrates a method for employing a machine learning model to predict application outputs and inputs, consistent with some implementations of the present concepts.

### DETAILED DESCRIPTION

### Overview

As noted above, application engines can provide various useful functions for application developers. For instance, application engines can perform complex physics or rendering calculations that save application developers a great deal of effort, as the application developers can rely on physics or rendering routines provided by the application engines. This relieves the application developers from having to hand-code their own physics or rendering routines.

Interactive applications, such as video games or training simulations, are one type of application that can benefit greatly from an application engine. These types of applications often involve complex physics or rendering calculations that are computed in real time, and can be implemented very efficiently in an application engine. However, extensive development efforts are still often employed to develop the rest of the code for an interactive application.

Machine learning has been employed in limited contexts to model application and/or user behavior in interactive applications. For instance, behavioral cloning techniques can train a machine learning model to predict how a human would interact with an application, and world modeling can predict future outputs from an application given user input. However, neither behavioral cloning nor world modeling fully captures the interactions between human users and applications in a unified manner.

The disclosed implementations can train a generative model to predict application output together with the inputs that a human being would provide in response to the application output. Because the generative model jointly learns both user and application behaviors, the generative model can generate new sequences of application and user interactions that can be employed for various purposes. For instance, the trained generative model can be employed to prototype application scenarios that can be subsequently hand-coded for execution within an application engine. The trained generative model can also be used to replace an application and/or application engine partly or entirely, e.g., relying on the trained generative model to generate application outputs at runtime in response to received user inputs. The trained generative model can also be employed to temporarily take over providing input to an application on behalf of a given user, e.g., in the event of a network disruption that prevents or delays network communications between an application and a user device.

Additionally, various example user interface (UI) mechanisms are described, which enable a user to efficiently and intuitively manipulate a trained generative model at inference time (also known as runtime). A user is able to guide the generative model to produce desired output sequences via intuitive inputs mechanisms that place minimal burden on the user. Among other things, mechanisms are provided to guide the output generation process by manipulating input sequences provided to the generative model. The improved UI mechanisms herein enable a given output sequence to be generated with reduced user interactions. Moreover, improved control over the generative model means fewer computational resources are wasted compared with a ‘trial-and-error’ approach in which a user has to repeatedly generate and discard output sequences that do not meet their requirements. Certain generative models (such as transformers) consume significant computational resources in generating even a single output sequence. Therefore, any reduction in the number of output sequences that need to be generated before a desired outcome is reached means not only reduced time and effort on the part for the user but also a significant improvement in computational efficiency.

The UI mechanisms described herein enable extended sequences to be generated. Certain generative architectures (such as transformer architectures) have limited “context windows”. In the broadest sense, a token means an element of a sequence, which can be used to represent any form of data (e.g. image, controller state, audio, text etc.). The context window means the maximum number of tokens across the input and output sequences combined (the longer the input sequence, the shorter the maximum output sequence). Among other things, the described techniques enable extended sequences to be generated (in excess of the context window) in a controlled manner, thus overcoming a technical constraint of generative architectures with finite context windows.

Certain example embodiments have general application to sequence-based generative models, in which alternative sequences of generated outputs can be generated, and new branches generated by selecting subsequences of such generated sequences and/or combining parts from different sequences as further inputs.

Example use-cases include (among others) application design using generated images, music composition by combining audio or music items, programming by selectively and combining sequences of code items, planning industrial actions (such as machine repair or maintenance actions) by selecting sequences of generated action indicators, building industrial simulation or other technical simulations (such as sequences simulated cyberattacks actions for system testing), generating/exploring different possible narratives with generated sequences of narrative items (e.g. comprising text and/or image data), visual ‘storyboarding’ used in television of film development, generating synthetic video sequences based on generated video frames etc. Certain application may be used to determine actions to perform on a system, such as security mitigation actions, repair or maintenance actions, tuning, adapting, modifying or replacing a machine (e.g. industrial machine, vehicle etc.), performing a maintenance or repair action performed on a machine, a vehicle manipulation action etc.

In a first embodiment a graphical user interface (GUI) provides a visual ‘branching’ mechanism in which sequences are displayed and a user can select elements of an existing sequences or sequences to quickly and efficiently generate a new input sequence. The new input sequence is, in turn, used to generate multiple candidate output sequences, which are displayed hierarchically on the GUI (in a ‘tree-like’) manner to convey their relationship to the existing sequence(s). The user can continue this process iteratively, by selecting new elements and generating further new sequences until a desired outcome is achieved. In this manner, the user can control how branches are generated, and can chose which branches to explore further (and which to ignore).

In a second embodiment, a GUI provide an image manipulation function, which can be used to visually modify one or more elements of an output sequence generated by a generative model. This results in a modified input sequence, which in turn is used to generate a further output sequence (guided by the user's modifications). For example, in a game design application, a user might add a new game character to one or more game images generated by a generative model. Those modified image(s) are then fed back to the generative model in a new input sequence, resulting in a new output sequence. The user's modification(s) need only provide rough guidance to the model (e.g., there is no requirement for them to match a visual aesthetic of the game images). The generative model will then be guided to incorporate similar modifications in a more appropriate manner that leverages the knowledge it has learned in training.

In a third embodiment, a generative model is used which has been trained to consume input sequences and generate output sequences containing images and controller states that link adjacent images (e.g., game images and game controller states linking the game images). A controller input mechanism is provided, which enables a user to define a controller state in an input sequence. By defining the input controller state, the user is able to control the generation of the output (for example, in a game design context, this approximates a gameplay experience during the design state; in one example implementation, the user is almost able to ‘play’ a game frame-by-frame, by performing an action on a physical or virtual game controller that not only causes the next frame to be generated by also influences its content).

### Machine Learning Algorithms

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### Terminology

For the purposes of this document, the term “application” refers to any type of executable software, firmware, or hardware logic. The term “interactive application” refers to an application that performs processing responsive to received user input and iteratively, frequently, or continually adjusts application output in response to the received user input. Video games and flight simulators are two examples of interactive applications. The term “application output” refers to outputs such as video, audio, or haptic output by an application to provide a user experience. The term “actual user input” refers to input actually provided by a user during a course of interaction with an application. Application outputs and inputs can also be generated by a generative machine learning model, as described elsewhere herein. One example use case considered herein is game design supported by a generative neural network trained on large number of training gameplay sequences. Training gameplay sequences are generated by recording game frames as video games are played, either by real users or by software agents (automated gameplay). In the examples below, each game frame comprises a game image (a ‘still’ captured from the video game and a current controller state of a physical or virtual game controller). In some implementations, a generative model is used with no explicit encoding to distinguish whether an observation token (e.g. image token) or action token (e.g. controller state token) should be generated next. Rather, the model learns to predict either observation or action tokens from its learned position embeddings, and ‘frames' are defined in terms of predefined token positions.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “generative model,” as used herein, refers to a machine learning model employed to generate new content. As discussed below, generative models can be trained to predict items in sequences of training data. When employed in inference mode, the output of a generative model can include new sequences of items that the model generates. The term “multi-modal model,” as used herein, refers to a machine learning model that operates on multiple categories or “modalities” of data. For instance, the following describes a generative model that is trained to produce application outputs, such as images, as well as application inputs, such as inputs representing controls from a video game controller.

A “neural dreaming model” is a generative model, based on a neural network architecture, that produces future output sequences of an application, e.g., future images from a video game. A neural dreaming model can be multi-modal, e.g., the neural dreaming model can also generate future sequences of inputs, such as video game controller inputs. A neural dreaming model can employ a transformer architecture. The term “transformer decoder” is used to refer to decoding layers of a transformer-based neural dreaming model to distinguish from decoders employed for purposes such as decoding of images.

### Example Workflow

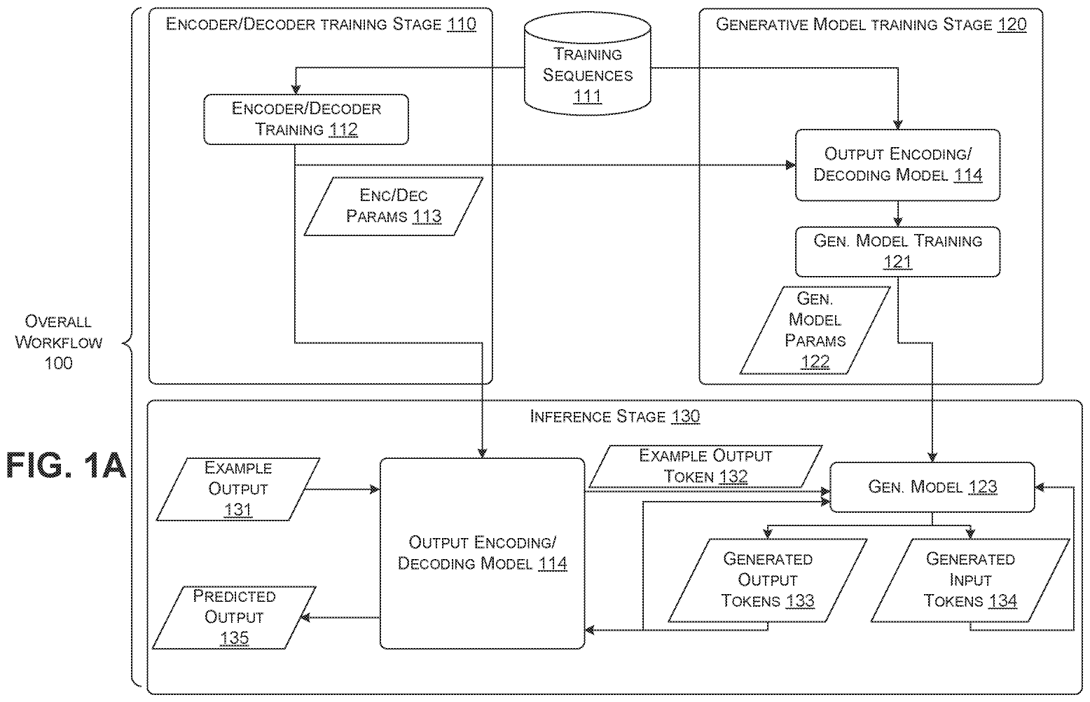

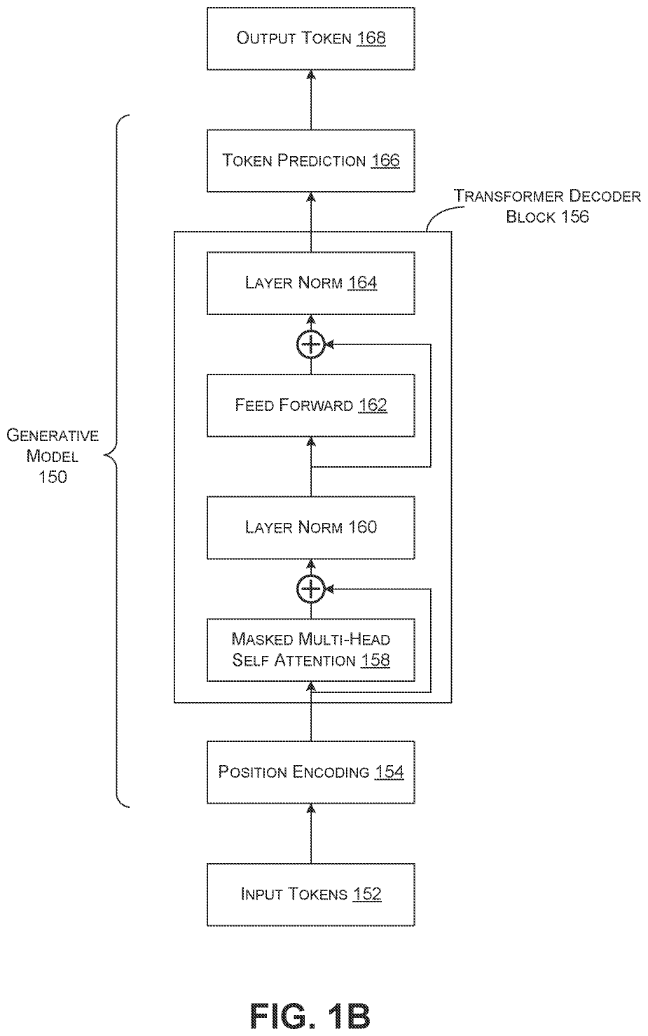

FIG. 1A shows an overall workflow 100, which involves an encoder/decoder training stage 110, a generative model training stage 120, and an inference stage 130. Generally speaking, the encoder/decoder training stage can train an encoder/decoder to encode and decode application outputs (e.g., images). The generative model training stage can train a generative model, such as a neural dreaming model, to predict sequences of application outputs and user inputs. The inference stage can employ the trained generative model to generate future sequences of application outputs and user inputs starting from a given point, e.g., a seed image.

The encoder/decoder training stage 110 and the generative model training stage 120 can employ training sequences 111, which can include training inputs and training outputs. For example, the training sequences can be obtained by logging executions of one or more applications. The training inputs can include inputs provided by human users during the executions, e.g., video game controller inputs, keyboard inputs, mouse inputs, spoken inputs, gestures, etc. The training outputs can include any type of output by the applications, e.g., video, audio, and/or haptic output produced by the applications in response to the user inputs.

The encoder/decoder training stage can involve accessing training outputs in the training sequences 111. As described more below, encoder/decoder training 112 can involve training an encoder/decoder model to represent application output, such as images, as tokens in a vector space. For instance, the encoder/decoder can map training images to tokens and then decode those tokens into corresponding images. A training objective can be defined that encourages the encoder/decoder to learn encoder/decoder parameters 113 that reduce or minimize the differences between the training images and the decoded or “reconstructed” images. Once the encoder/decoder training stage is complete, the encoder/decoder parameters can be output for use by output encoding/decoding model 114, which can be employed in both the generative model training stage 120 and the inference stage 130 as described more below.

Generative model training stage 120 involves performing generative model training 121 to obtain generative model parameters 122. During generative model training, the generative model attempts to predict the input tokens and output tokens that are present in a given training sequence. As described more below, in some cases, the generative model is a transformer, and techniques for self-supervised learning of transformer parameters are employed, e.g., next token prediction. In other cases, bidirectional training techniques can be employed, e.g., by predicting preceding as well as subsequent tokens. To obtain input tokens representing inputs in the training sequences, each training input can be represented as one or more values, e.g., a string of bits. A deterministic function can be employed to map different user input mechanisms (e.g., button presses, joystick direction, etc.) to different values, such as bits, in a given input token. To obtain output tokens representing outputs in the training sequences, the output encoding/decoding model can be employed to map the outputs in the training sequences into corresponding output tokens. When generative model training stage 120 is complete, the generative model parameters 122 can be output for use in the inference stage 130 by generative model 123.

Inference stage 130 involves receiving an example output 131. For instance, the example output can be a seed image that conveys a seeded application state that a developer wishes to use as a starting point for subsequent predictions. The example output is processed by the output encoding/decoding model 114 using the learned encoder/decoder parameters 113 to obtain an example output token 132, which represents the example output in a vector space. The example output token is input to generative model 123. The generative model uses the generative model parameters 122 to produce generated output tokens 133 and generated input tokens 134, which are input back to the generative model to continue generating sequences of generated output and input tokens. The generated output tokens are also decoded by the output encoding/decoding model to produce generated output 135, e.g., by decoding the generated output tokens to obtain images.

Note that FIG. 1A shows an example where the generative model 123 employs its own generated inputs to predict future inputs and outputs during inference stage 130. Said another way, the generative model can “dream” by generating new sequences of user/application interactions, in some cases without receiving any input from a user. As described more below, however, in other cases, the generated inputs can be discarded and actual user inputs can be provided to the generative model. In this case, the user is effectively interacting with the model acting directly as an interactive application. Also, note that FIG. 1A shows separate training stages for encoding/decoding and generative model training. However, as discussed more below, in some cases, joint training of encoder/decoder and generative models can be employed.

### Example Decoder-Based Language Model

FIG. 1B illustrates an exemplary generative model 150 that can be employed using the disclosed implementations. Generative model 150 can receive input tokens 152, e.g., input tokens representing user input or output tokens representing application output. Position encoding 154 represents the location of each token in order relative to the other tokens in a sequence of input tokens.

The tokens and position encodings are processed in one or more transformer decoder blocks 156. Each transformer decoder block implements masked multi-head self-attention 158, which is a mechanism relating different positions of tokens within a given sequence of tokens to compute the similarities between those tokens. Each token is represented as a weighted sum of other tokens in the input. Attention is only applied for already-decoded values, and future values are masked. Layer normalization 160 normalizes features to mean values of 0 and variance to 1, resulting in smooth gradients. Feed forward layer 162 transforms these features into a representation suitable for the next iteration of decoding, after which another layer normalization 164 is applied. Multiple instances of transformer decoder blocks can operate sequentially on input tokens, with each subsequent transformer decoder block operating on the output of a preceding transformer decoder block. After the final transformer decoding block, token prediction layer 166 can predict the next token in the sequence, which is output as output token 168 and also fed back into the generative model.

Generative model 150 is an example of a transformer-based generative model. For example, generative model 150 could be implemented using one or more versions of models such as ChatGPT, BLOOM, PaLM, and/or LLaMA. Note that other types of generative models, e.g., recurrent models, can also be employed.

### First Example Training Sequence

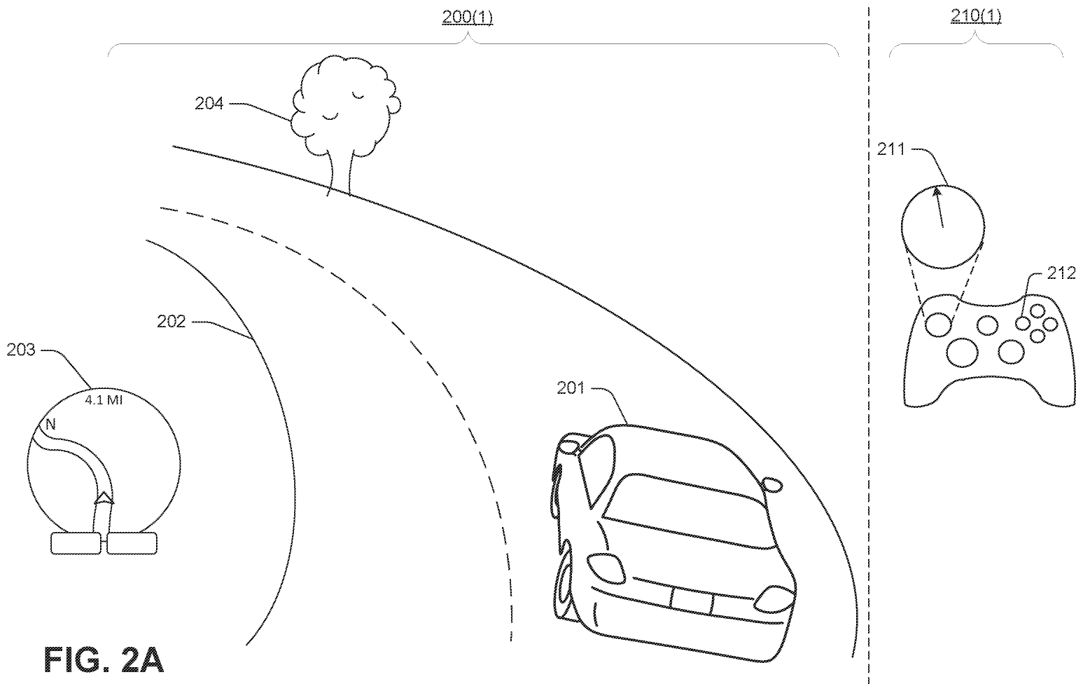

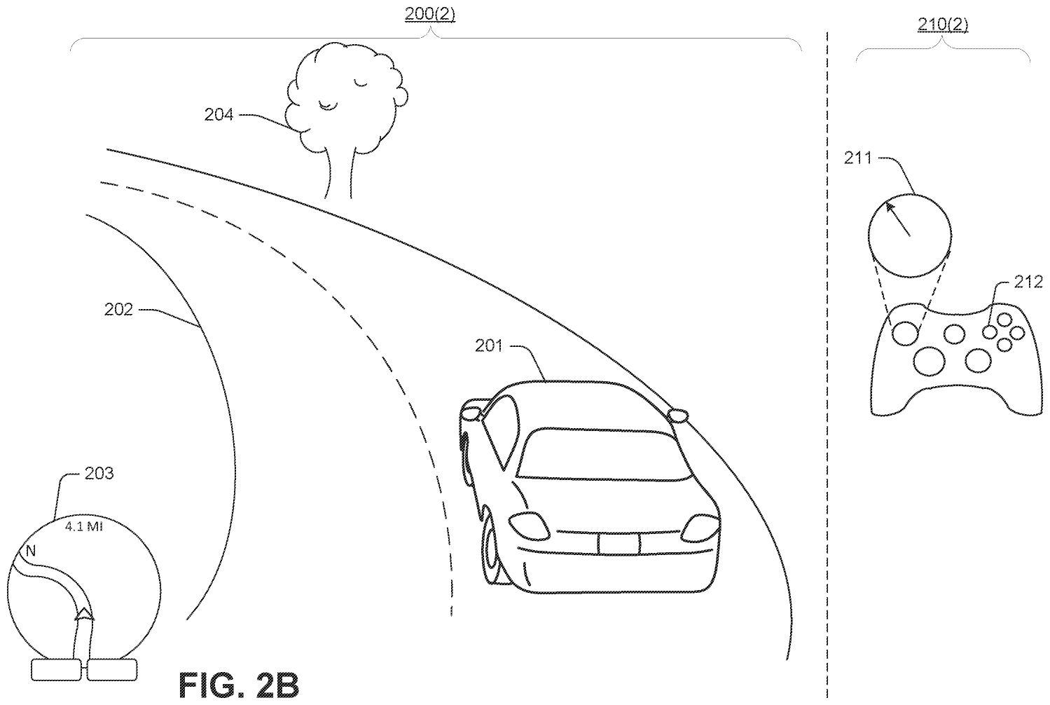

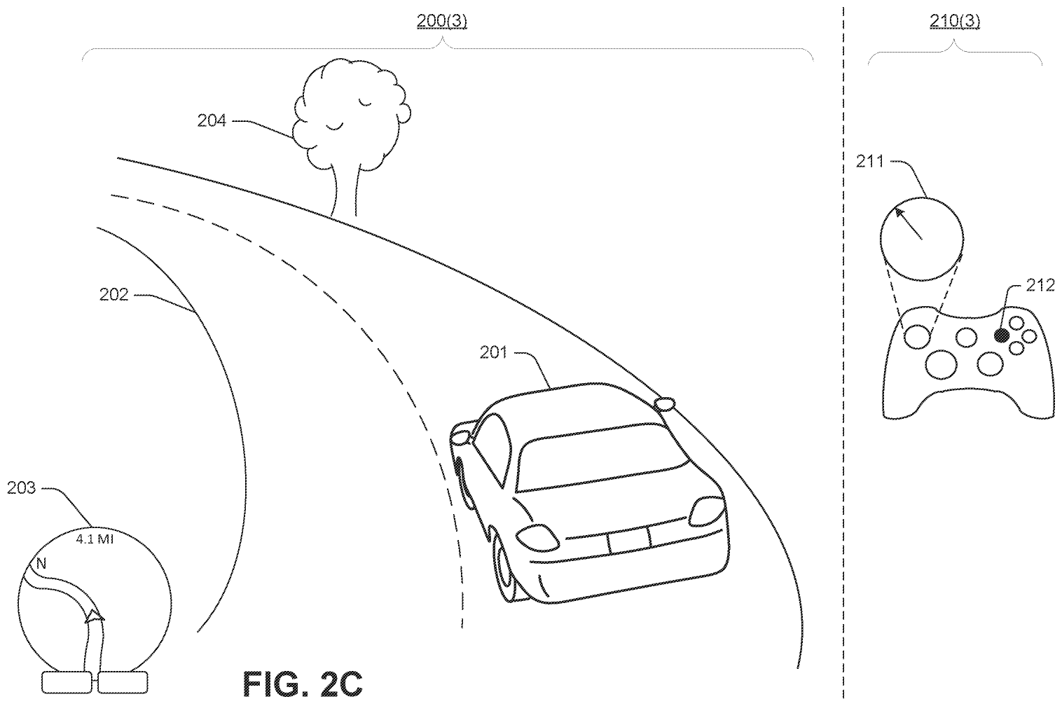

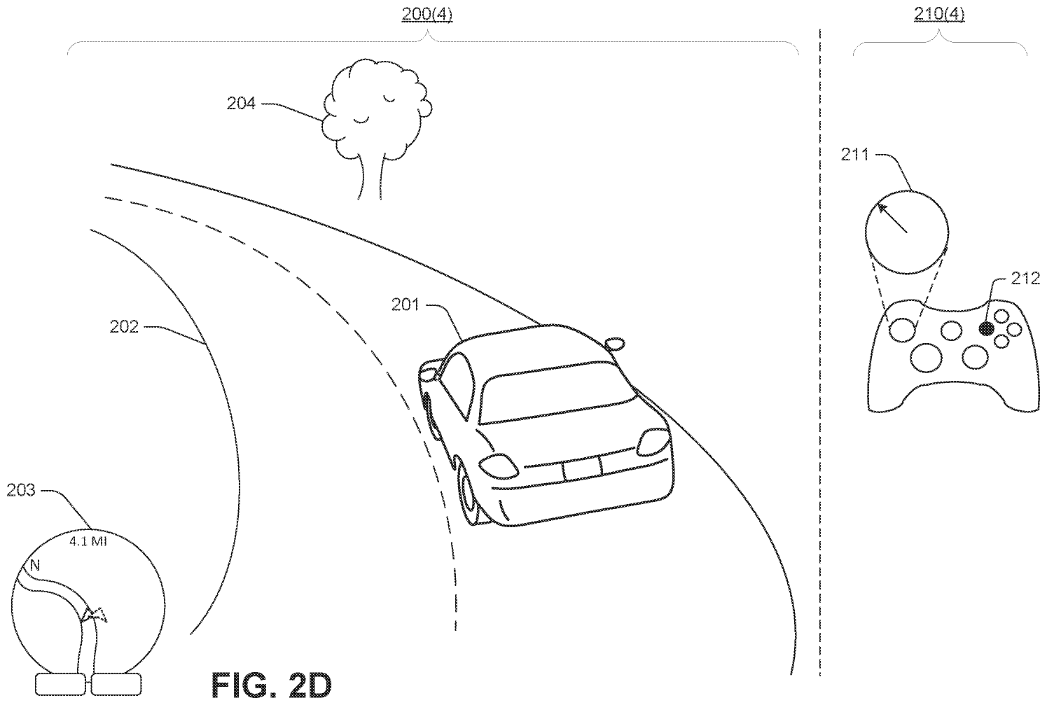

FIGS. 2A-2D collectively show an example training sequence from a first application, e.g., a driving game. For the following discussion, assume that a user played a driving video game and that the output of the driving video game was logged together with the user's inputs while they played the game. FIG. 2A shows example output 200(1) of the driving video and associated example input 210(1) provided by the user at a first time. FIG. 2B shows example output 200(2) of the driving video game and associated example input 210(2) provided by the user at a second time. FIG. 2C shows example output 200(3) of the driving video game and associated example input 210(3) provided by the user at a third time. FIG. 2D shows example output 200(4) of the driving video game and associated example input 210(4) provided by the user at a fourth time.

Referring to FIG. 2A, output 200(1) shows a car 201 moving on a road 202 with a map inset 203 showing the position of the car on the road, with a tree 204 in the background. Example input 210(1) shows controller inputs that were entered by a user while example output 200(1) was being output by the driving game. The controller inputs include a directional input 211, which steers the car, and an acceleration input 212, which accelerates the car. In FIG. 2A, the car is heading almost straight ahead toward a left turn, and the user is not accelerating the car.

FIG. 2B shows a subsequent point in the training sequence, where the user has corrected their steering by turning more sharply to the left, as shown by directional input 211 in example input 210(2). The car correspondingly turns more sharply into the left turn, as shown by example output 200(2). FIG. 2C continues the training sequence, with the user having corrected their steering and deciding to accelerate the car, as shown by acceleration input 212 in by example input 210(3). FIG. 2D shows the car moving further down the road while the user continues to accelerate.

### Second Example Training Sequence

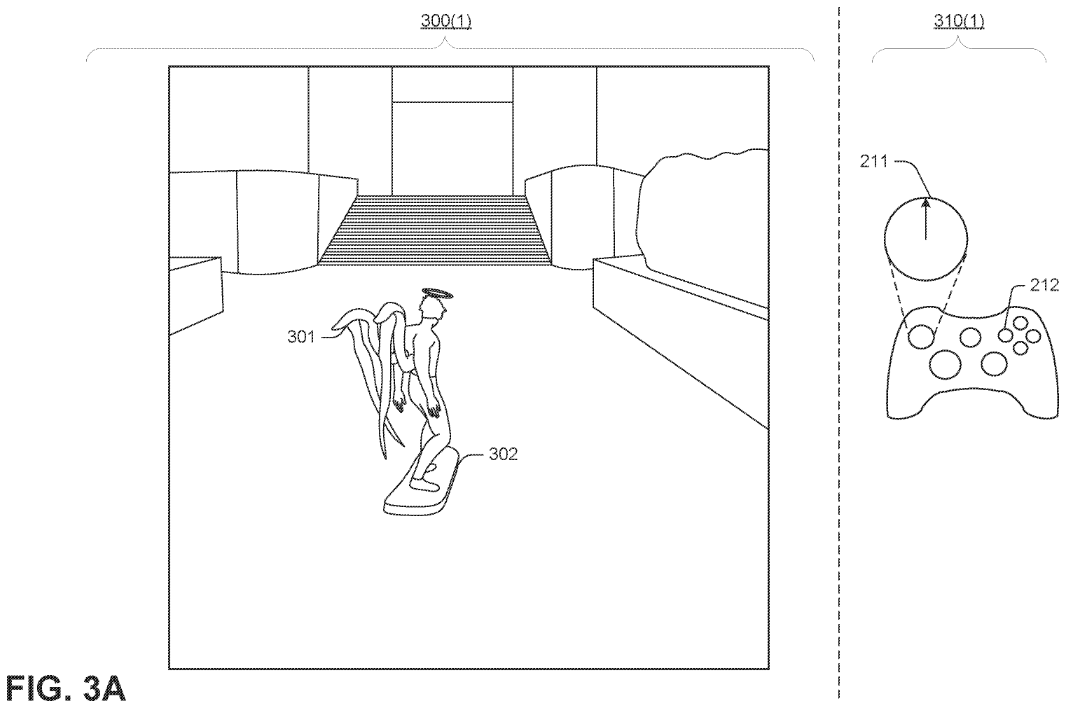

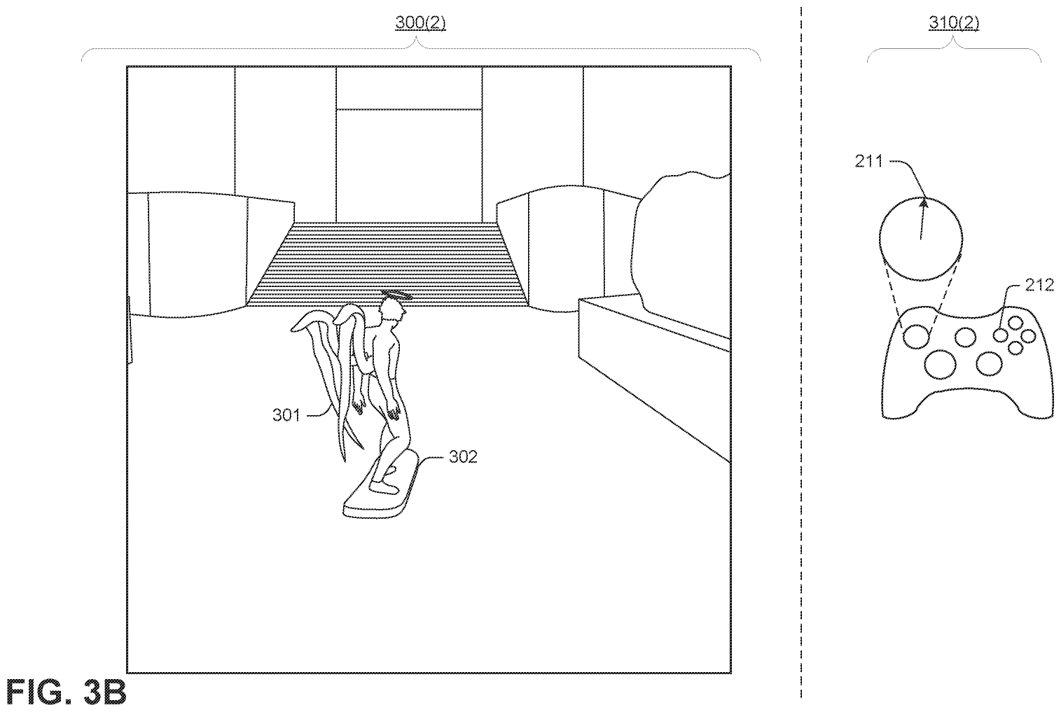

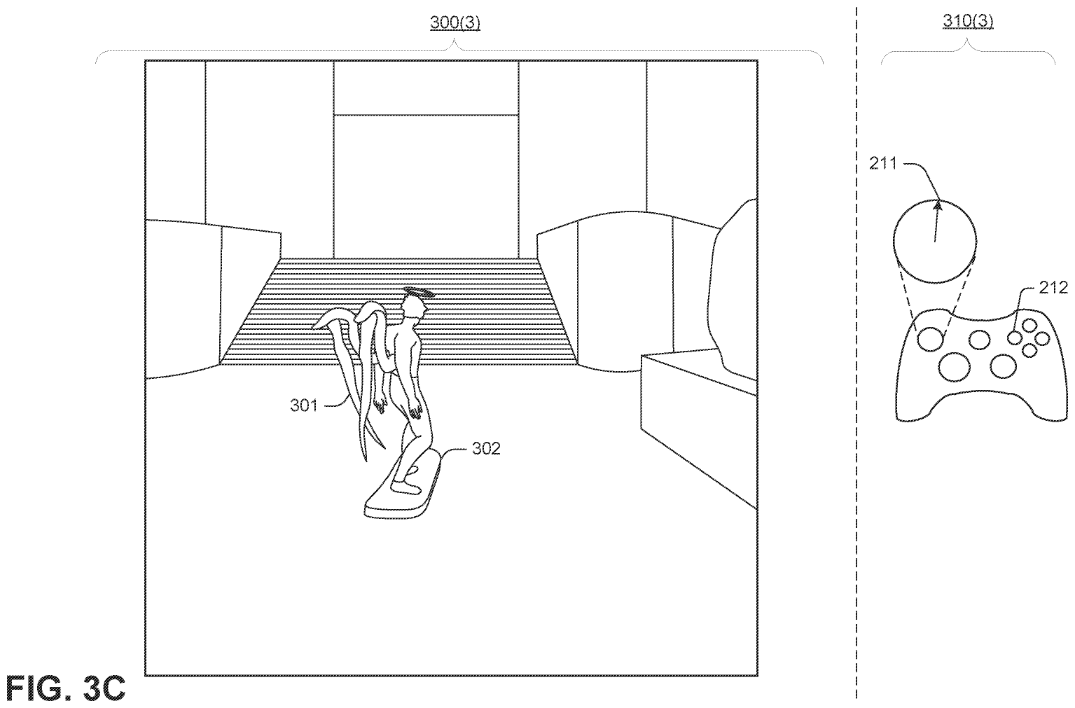

FIGS. 3A-3D collectively show an example training sequence from a second application, e.g., a fantasy game. For the following discussion, assume that a user played the fantasy video game and that the output of the fantasy video game was logged together with the user's inputs while they played the game, similarly to the driving video game example discussed previously. FIG. 3A shows example output 300(1) of the fantasy video game and associated example input 310(1) provided by the user at a first time. FIG. 3B shows example output 300(2) of the fantasy video game and associated example input 310(2) provided by the user at a second time. FIG. 3C shows example output 300(3) of the fantasy video game and associated example input 310(3) provided by the user at a third time. FIG. 3D shows example output 300(4) of the fantasy video game and associated example input 310(4) provided by the user at a fourth time.

Referring to FIG. 3A, example output 300(1) shows a character 301 on a hoverboard 302. Example input 310(1) shows directional input 211 pointed directly forward. At this time, the user is employing the directional input to move the character forward through the scene. FIG. 3B shows a subsequent point in the training sequence, where the user has moved the directional input slightly to the right. In response, the character turns slightly to the right in the example output 300(2). In FIGS. 3C and 3D, the inputs remain consistent while the application output shows the character continuing to move through the scene.

Note that FIGS. 3A-3D do not show the use of the acceleration input 212. In the fantasy video game, the directional input alone controls the movement of the character and a separate acceleration input is not utilized to move the character. Thus, the two different applications use different control paradigms.

### Example Generated Sequence

Consider a generative model that has been trained on thousands of training sequences similar to the two training sequences described above. The generative model could learn what types of images the applications tend to output in response to user inputs, as well as what user inputs the users tend to provide in response to the images they see. For instance, the generative model could learn that users tend to move the directional input to the left when heading into a left turn, that applications can move objects such as cars or characters forward in response to acceleration inputs or directional inputs, etc. Given an example output from which to start, the generative model can then produce its own generated sequences of outputs and inputs.

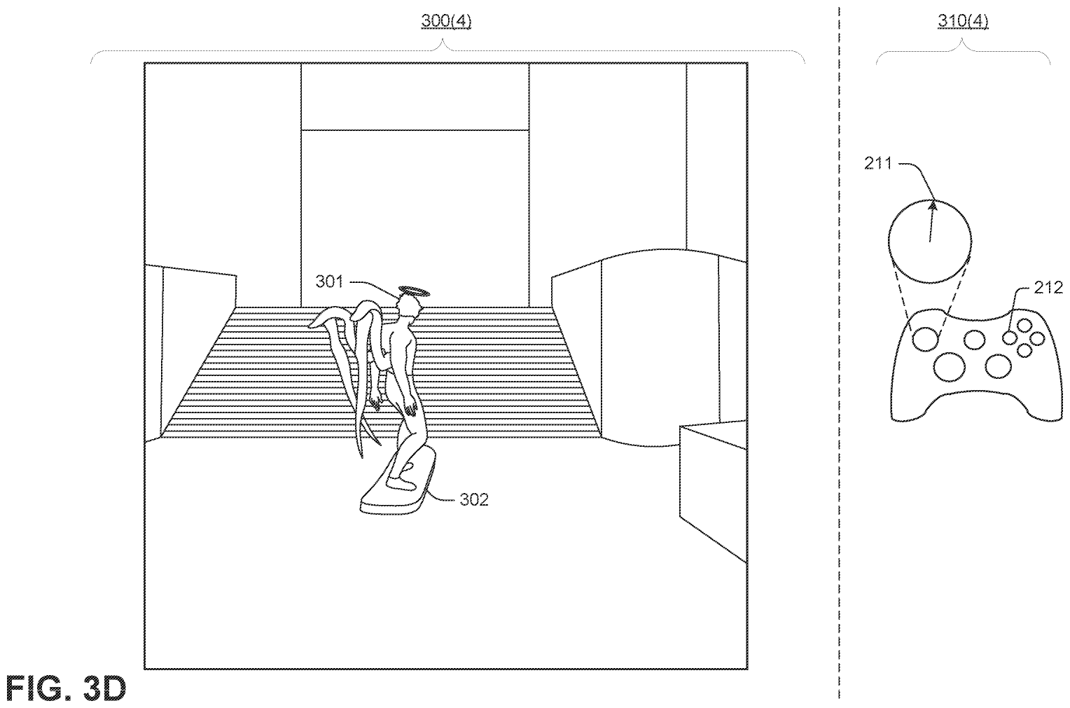

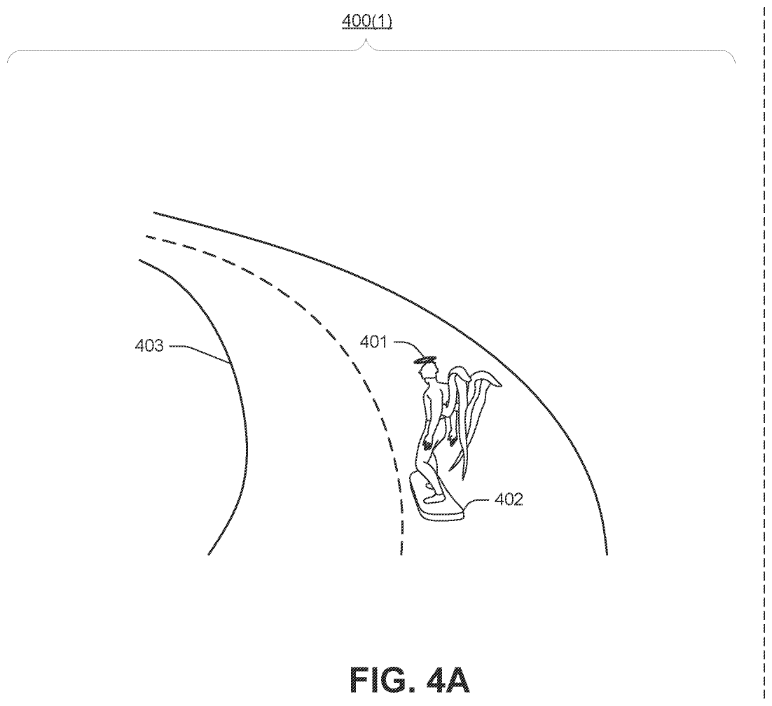

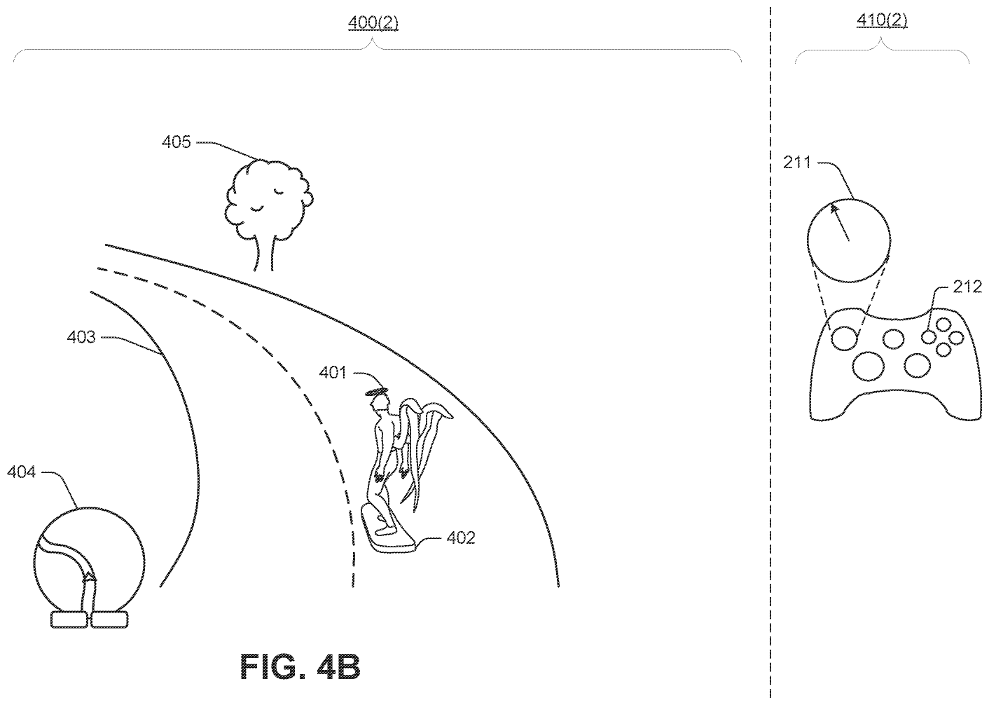

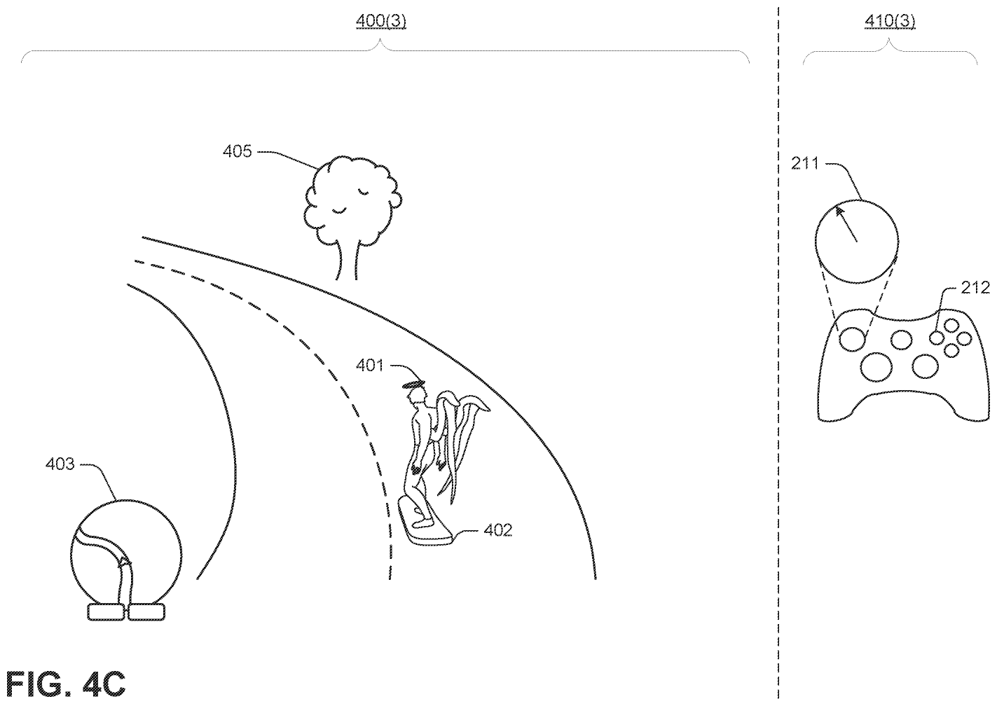

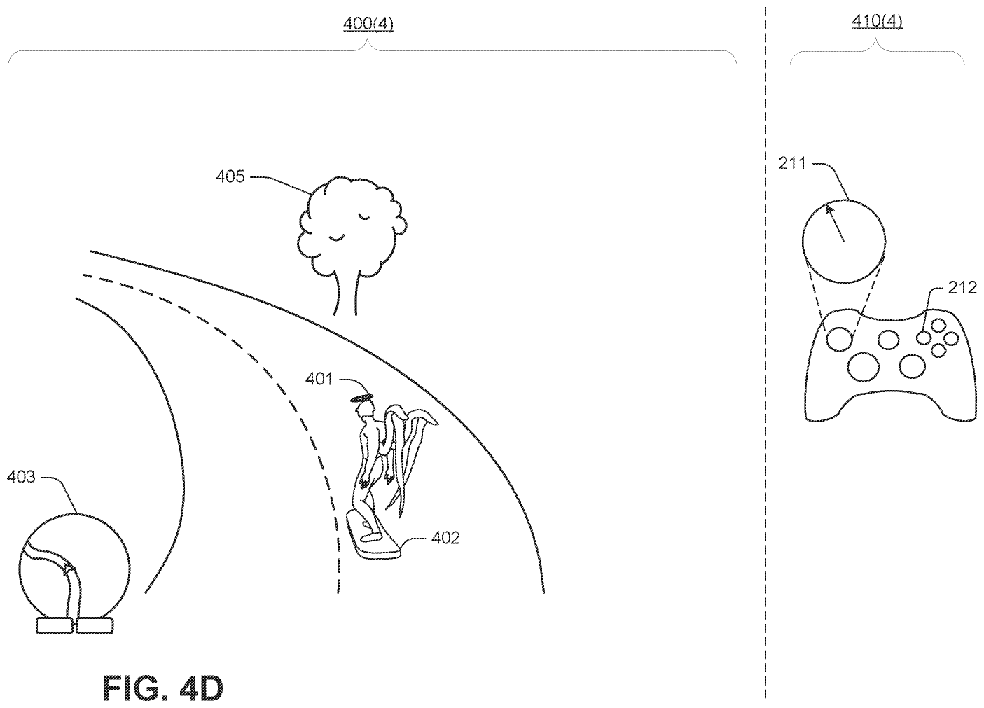

Consider a developer that wishes to see a gaming experience where a character on a hoverboard drives the hoverboard on a road, in a manner similar to a car. The developer can provide an example output 400(1) to the generative model as shown in FIG. 4A. The example output shows a character 401 on a hoverboard 402 driving on a road 403. FIG. 4B-4D collectively show an example generated sequence that could be generated by a generative model trained on the training sequences described above. Note that the developer can also provide an example input but does not necessarily need to do so, and no example input is shown in FIG. 4A.

FIG. 4B shows generated output 400(2), which shows character 401 moving along the road 403. The generative model can generate map inset 404 and tree 405, e.g., as learned from the driving game. The generative model can also adjust the orientation of the character and the hoverboard to match the trajectory on the road, e.g., as learned from the fantasy game. The generative model can also produce generated input 410(2), which shows the directional input steering the hoverboard character to the left. FIGS. 4C and 4D show that the generative model predicts the character will continue to move down the road via generated outputs 400(3) and 400(4), respectively while the input gently steers the character through the turn as shown via generated inputs 410(3) and 410(4).

Note that in FIGS. 4B, 4C, and 4D, the generative model predicts that the input will gently steer the character along the road using the directional input 211, without using the acceleration input. This could be, for example, because the generative model has learned the control paradigm from the fantasy application, e.g., that the acceleration input is not necessary to move the character forward and that the directional input alone can do so. The generative model also correctly updates the position of the character on map inset 404 as the character travels down the road. This could be, for example, because the generative model has learned to update the map inset from the driving application. More generally, the trained generative model has learned to utilize concepts from both applications that were used to train the model to provide a coherent user experience. By starting with the example shown in FIG. 4A, the trained generative model is able to generate a sequence of later application outputs and inputs independently. As described more below, this allows the generative model to be employed for a wide range of applications, from prototyping of new applications that are subsequently hand-coded to running new applications entirely within the trained model.

### Specific Implementation

The following describes a specific implementation of the disclosed concepts, named WHAM (World and Human Action Model). WHAM is a model that jointly learns to do both behavioral cloning and world modeling. WHAM encodes image observations as discrete tokens using an image encoder, and the image tokens are interleaved with action tokens (representing user inputs) to form training sequences. A transformer model is then trained to do next-token prediction on a large-scale human gameplay dataset.

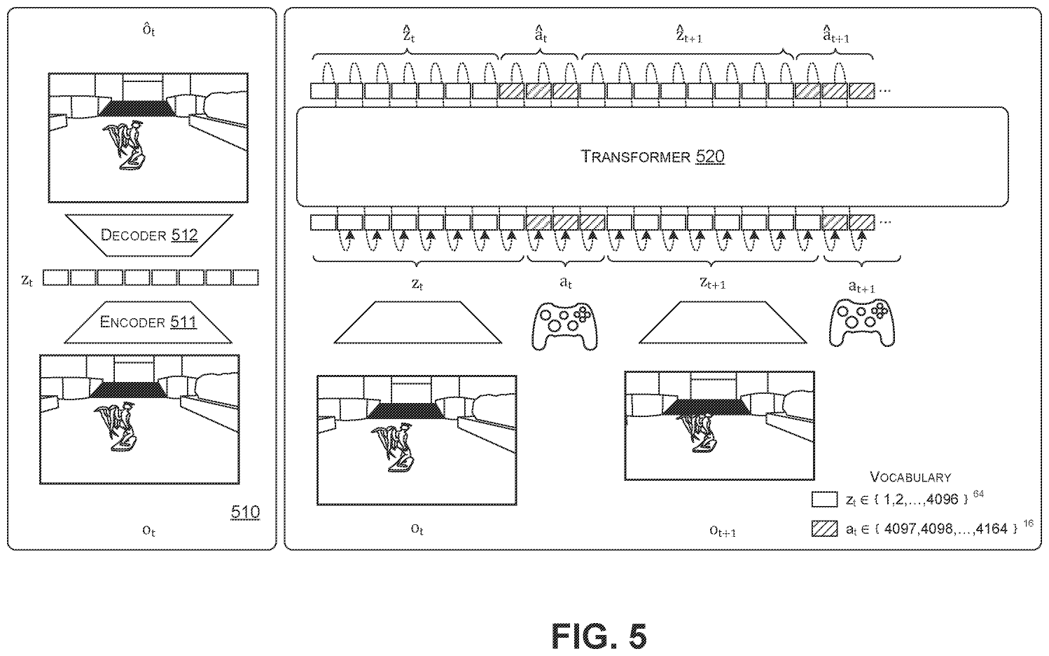

FIG. 5 presents an overview of WHAM, which structures trajectories as an interleaved sequence of observation and action tokens. An encoder/decoder 510 includes an encoder 511 and a decoder 512. The encoder performs tokenization of images, from observation space, oₜ∈R^{H×W×3}, to a compact discrete latent space zₜ∈{1, 2, . . . , Vₒ}^{d}^{_{z}}, for vocabulary size Vₒ and bottleneck size d_{z}. Each image can be encoded as one or more image tokens. The decoder can transform one or more image tokens into a corresponding image in the observation space. A transformer 520 (e.g., a causal transformer decoder employed as a generative model) is then trained to predict these latent observation tokens \hat{z}ₜ and discretized action tokens, \hat{α}ₜ, for successive timesteps, t∈N.

Notation. zₜ refers to all tokens encoding an observation oₜ at timestep t, and zₜⁱ when referring to the P^{th} token of that latent observation. A similar convention applies to aₜ and aⁱₜ. Hatted variables denote model predictions.

Observation tokenization. WHAM's image encoder provides a deterministic mapping, Enc_{θ}(oₜ)→zₜ, while the decoder deterministically maps, Dec_{θ}(zₜ)→ôₜ. To allow the transformer model to operate on discrete tokens, a model such as the VQVAE (Van Den Oord, et al., “Neural discrete representation learning,” Advances in neural information processing systems, 30, 2017) encoder/decoder architecture can be employed. VQVAE is a convolutional autoencoder, with a quantization layer at the bottleneck. Observations are first mapped to a continuous latent vector, wₜ∈R^{d}^{_{z×d}}. These continuous vectors are then quantized to the nearest VQVAE codebook vector, eⱼ∈R^{d} for j∈{1, 2, . . . , Vₒ}, via, zₜⁱ=arg minⱼ∥eⱼ−ωₜⁱ∥2. VQVAE uses two reconstruction losses; pixelwise MSE, and a perceptual loss (Zhang, et al., “The unreasonable effectiveness of deep features as a perceptual metric,” In Proceedings of the IEEE conference on computer vision and pattern recognition, pages 586-595, 2018).

Another model that can be employed for the encoder/decoder is VQGAN (Esser, et al., “Taming transformers for high-resolution image synthesis,” In Proceedings of the IEEE/CVF conference on computer vision and pattern recognition, pages 12873-12883, 2021). VQGAN introduced several innovations. For instance, VQGAN adds a further reconstruction loss: a GAN discriminator is trained to distinguish patches from the reconstruction from patches from the original image. In preliminary experiments discussed below, VQGAN produced higher-quality images compared to VQVAE. Comparing the two provides insights on whether perceptual quality correlates with overall model performance.

Action tokenization. The action space is an Xbox controller, which has 12 binary buttons and two joysticks. Each joystick is decomposed into an x and y component, which are discretized into 11 buckets. This creates 16=12+4 total action dimensions. Vocabulary is assigned so that each action dimension has its own unique tokens, two for buttons, and 11 for each joystick dimension, giving a total action vocabulary size of, Vₐ:=68=(12×2)+(4×11).

### Specific Transformer Example

Following the tokenization of observations and actions as described above, training sequences, c, take the form:

$$c [ {z}_{t}^{0} , {z}_{t}^{1} , … , {z}_{t}^{{d}_{z} - 1} , {a}_{t}^{0} , {a}_{t}^{1} , … , {a}_{t}^{15} , {z}_{t + 1}^{0} , {z}_{t + 1}^{1} , … {z}_{t + 1}^{{d}_{z} - 1} , {a}_{t + 1}^{0} , {a}_{t + 1}^{1} , … , {a}_{t + 1}^{15} , … ] , \qquad ( 1 )$$

where each item of the sequence, cᵢ∈{0, 1, . . . , Vₒ+Vₐ}, is simply an integer within the vocabulary. These sequences allow for training of transformer models on next-token prediction, e.g. by maximizing the likelihood, p(ĉᵢ=cᵢ|c_{<i}).

WHAM employs a causal transformer architecture with 205M parameters. No explicit encoding is employed to distinguish whether an observation or action token should be generated next. Rather, the model learns to predict either observation or action tokens from its learned position embeddings. At test time, illegal token selections are masked out—e.g. when predicting an observation token, action token logits are set to negative infinity. Sequences are constructed so that a complete observation, beginning from zₜ⁰, comes first. WHAM was trained on sequences of ten observation tokens and ten action tokens. WHAM samples dimensions autoregressively allowing samples from the joint distribution, p(zₜᵢ,zₜᵢ₊₁,zₜᵢ₊₂)=p(zₜᵢ)p(zₜᵢ₊₁|zₜᵢ)p(zₜᵢ₊₂|zₜᵢ,zₜᵢ₊₁).

### Training Regimes

Two regimes for training WHAM are described and compared below. The first regime involves training the encoder/decoder first, with only a reconstruction loss, then freezing the encoder/decoder weights and training the transformer—as in Micheli, et al., “Transformers are sample efficient world models,” In International Conference on Learning Representations, 2023). The second regime involves beginning with the pretrained encoder/decoder checkpoint, continuing to train the encoder/decoder jointly with the transformer—similar to Hafner, et al., “Mastering atari with discrete world models,” arXiv preprint arXiv:2010.02193, 20. Here, the encoder receives gradients from both the decoder reconstruction loss and the next-token prediction loss. Joint training might encourage the extracted observation representations, zₜ, to prioritize information that helps action prediction (such as salient game details). However, this comes at the cost of higher VRAM requirements/smaller batch sizes. One useful property of the first training regime is that image observations can be tokenized ahead of time, streamlining dataloading and training.

### Game Environments and Dataset

The following details the environment and dataset used throughout the experiments described below. The video game Bleeding Edge was used as a testbed environment. Bleeding Edge is a team-based 4v4 online multi-player video game. Players select from thirteen possible heroes, each with different abilities. The camera is set in a third-person view, which makes the environment partially observable. Experiments were conducted using the Power Collection game mode. Players compete to collect power cells that spawn at random locations on the map at fixed time intervals. Points are scored by delivering these power cells to hand-in platforms, which activate for a limited time period. Throughout this, the two teams engage in melee and range-style combat, which can also earn points. The game dynamics are complex, both moment-by-moment through the precise control needed for fights, and also through longer-term strategies required for the power cell objective, which benefits from team coordination. The data and experiments focus on a single map called Skygarden, which is spread over several islands each with multiple elevation levels.

Bleeding Edge visuals are highly complex. The 3D view provides important game-relevant information about the map geometry, power cells and other players. Heads-up-display (HUD) elements such as the mini-map and health information are small details on the screen but carry important information. Overall, the Bleeding Edge environment combines several types of complexity that are absent in the benchmark environments used in prior world modeling research.

### Human Data Collection

Human gameplay data was recorded as part of the regular gameplay process, in order to enable in-game functionality as well as to support future research. Games were recorded on the servers that hosted the games in the form of so-called replay files. Recordings include a representation of the internal game state and controller actions of all players. To minimize risk to human subjects, any personally identifiable information (Xbox user ID) was removed when extracting the data used for this study from the original replays.

### Dataset

For the experiments outlined below, a dataset was extracted from the replay files. Human gameplay actions were extracted as hybrid (discrete and continuous) controls. Joystick actions were represented as continuous values that control the player direction (left joystick) and camera direction (right joystick). Controller buttons were represented by discrete values. Image data was stored as MP4s. The resulting data was cleaned to remove errors and data from bad actors as detailed below, after which data remained for 8,788 matches, yielding 71,940 individual player trajectories, totaling 3.87TiB on disk. These matches were recorded between 09-02-2020 and 10-19-2022, and amount to 56.3 days of match time, or 9875 hours (1.12 years) of individual game play. Sampled at a rate of 10 Hz, this equates to 355.5M frames. This individual game play data was divided into training/validation/test sets by dividing the 8788 matches with an 80:10:10 split.

### Experimental Results

The following results evaluate the ability of the trained models to play a version of the game. Game relevant statistics such as (human normalized) damage dealt to opponents, objectives (power cells) collected, and healing done per episode are reported. These statistics convey the ability of the trained model to generate inputs to the game that cause corresponding results, such as damaging opponents, collecting power cells, and healing. The results are averaged over 750 episodes. Starting states are sampled randomly from the dataset. Episodes last for 30 seconds of game-time.

Linear probing was performed to obtain insights into what game-relevant concepts the models' internal representations capture. Using privileged game state information, multiple binary classification tasks were constructed, such as ‘is the current hero Daemon?’ or ‘will the character die in the next two seconds?’. Linear logistic regression probes were then trained using the model's hidden activations as input. Results were normalized relative to a randomly initialized CNN (convolutional neural network), and an oracle achieving 100% accuracy.

Dreaming evaluates the ability of WHAM to generate plausible future observations. Dreams were conditions on a ground-truth context of observations and actions from a reference human trajectory up to timestep t. One-step dreaming—the model's capability to autoregressively predict the immediate next observation \hat{z}ₜ₊₁, was evaluated, and also multi-step dreaming—predicting \hat{z}ₜ₊₁, \hat{z}ₜ₊₂, . . . , but conditioned on ground-truth human actions, aₜ₊₁, aₜ₊₂, . . . . To quantify the quality of the imagined sequences, cosine similarity between the true and predicted encoder embeddings was computed at each step.

These metrics allow quantification of the performance of different models relative to one another and enable understanding of the impact of key modeling choices. The following discussion evaluates a range of modeling choices that have been trained for a fixed compute budget. Unless detailed otherwise, performance is reported after 20k update steps.

### Training & Evaluation Compute

The encoder/decoder models were trained on 4×A6000 GPUs for up to four days, while the transformer models each used 8×V100 GPUs for four days. For all evaluation runs we used virtual machines with either M60, A6000 or A100 NVIDIA GPU cards.

For reference, the models and variants are referred to using the form {W}HAM-(Joint)-64{VQVAE|VQGAN}, where WHAM denotes a World and Human Action Model, and HAM denotes an action-only model. Joint indicates that the encoder was trained jointly with the sequence model. 64 denotes the encoder's bottleneck size, d_{z}, and VQVAE|VQGAN denotes the encoder/decoder architecture.

### Results of Predicting Actions and Observations

As described below, WHAM can learn to predict both user inputs (actions) and application outputs (observations) in a single model, without necessarily compromising performance on either component. This type of joint model can provide additional capabilities and sidesteps the need to train two separate models. Ideally, this should not come at the expense of a tradeoff of model capacity. The following confirms that additionally predicting the more complex observation tokens does not negatively impact the model's ability to predict actions.

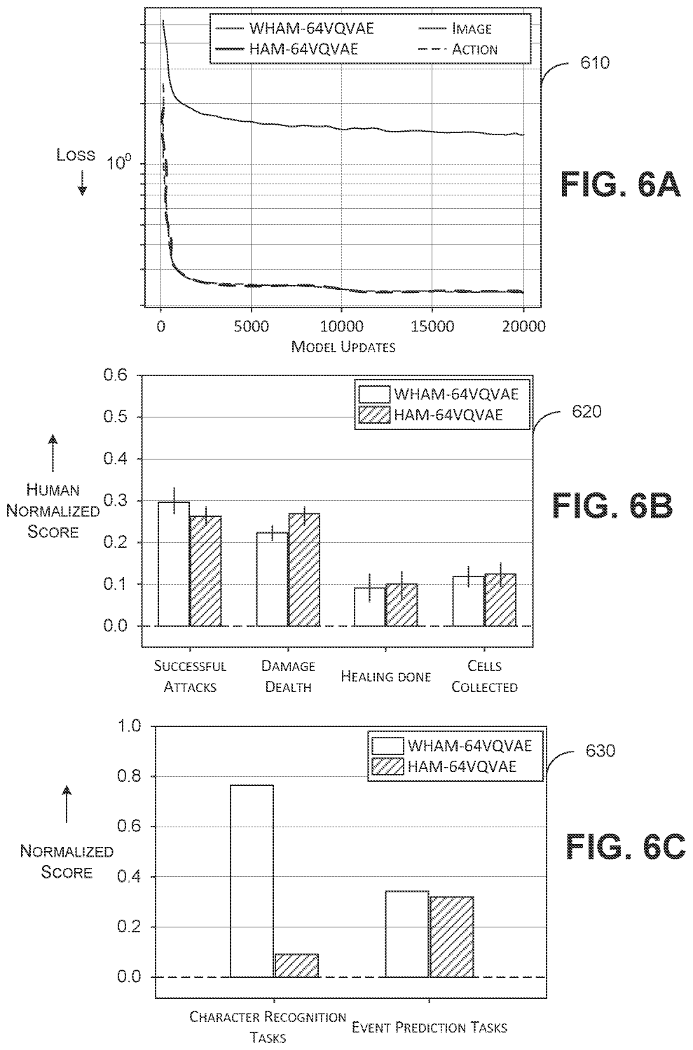

To investigate this, the following compares a model that predicts only actions (HAM-64VQVAE), with a model that predicts both actions and observations (WHAM-64VQVAE). Other hyperparameters are shared—using a VQVAE trained independently from the transformer, and set d_{z}=64. FIG. 6A shows a training loss graph 610, FIG. 6B shows a rollout performance graph 620, and FIG. 6C shows a linear probe results graph 630. Both models achieve similar cross-entropy loss over action tokens, and similar online performance. Linear probe results graph 630 shows that the representations of the WHAM model are encoding more game-relevant information. In particular, the WHAM model is encoding which character is currently being used—information that the WHAM model can capture as a side effect of predicting the observation tokens. Note that WHAM does not appear to compromise on the ability to predict actions relative to the HAM model that predicts only actions.

### Training of Encoder/Decoder and Transformer

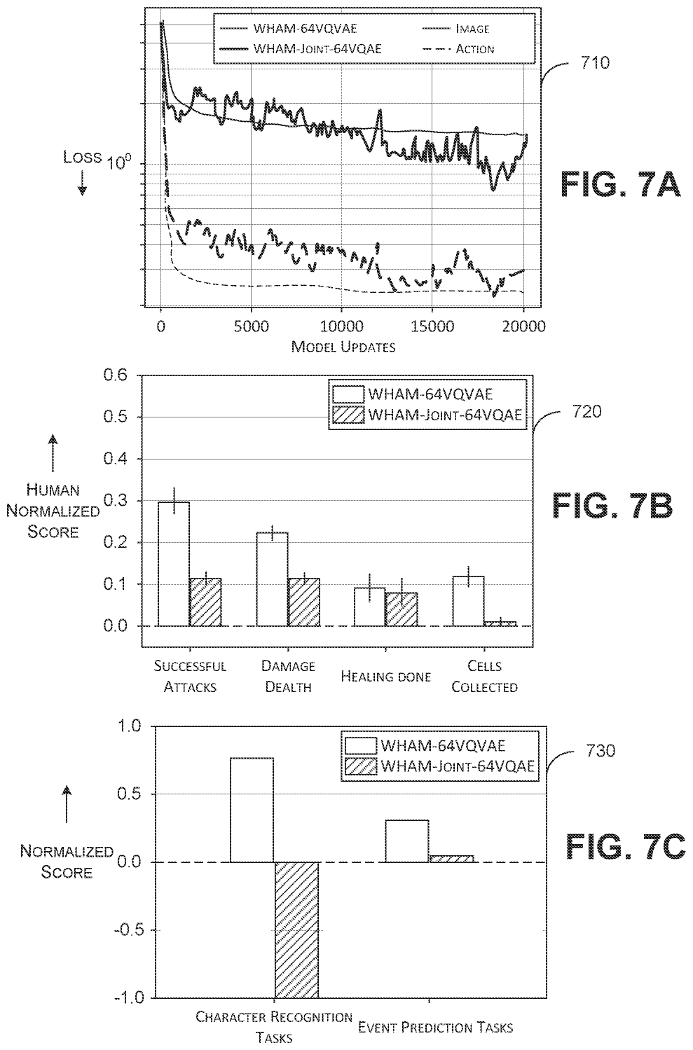

As noted above, several training regimes were implemented: 1) training the encoder/decoder on a reconstruction loss, and then training the transformer separately, and 2) continuing to train the encoder/decoder jointly with the transformer. FIG. 7A shows training loss graph 710 and FIG. 7B shows rollout performance graph 720 for the two training regimes. These results compare the performance of WHAM-64VQVAE with the pre-trained VQVAE described previously to that of the jointly trained WHAM-Joint-64VQVAE model. Note that WHAM-Joint-64VQVAE exhibits significantly more unstable training than using the pre-trained encoder. One potential explanation is that having the encoder provide both the inputs and the targets for training creates a harmful feedback loop. This results in significantly worse performance for WHAM-Joint-64VQVAE when it is rolled out online. Turning to the FIG. 7C, which shows linear probe results graph 730, note that the representations for the joint training regime suffer, with WHAM-Joint-64VQVAE performing significantly worse at character identification.

Joint training again leads to a significantly less stable cross-entropy loss over the observation tokens. The joint loss appears lower, but this kind of direct comparison is misleading—unlike for the action tokens, the observation token targets are now generated by different encoders, and for the joint model, these change through training. For a more grounded comparison of model quality, the reconstructions of both models can be inspected. The result is substantially worse for the jointly trained model, with highly blurred reconstructed images that miss game relevant details. It does not appear that a joint training regime allows models to capture more game relevant detail at the current scale of compute. This is a promising result, because pre-training and freezing the observation encoder leads to very large gains in training efficiency and thus more scalable models.

### Choice of Encoder/Decoder Model

WHAM has the ability to model the world at future timesteps based on its own generated inputs, also referred to as ‘dreaming.’ The decoder maps from generated latent tokens \hat{z}ₜ to images, ôₜ, allowing unique insight into what WHAM can represent and predict. For instance, inspection of the dreamed trajectories can be employed to qualitatively assess how well WHAM models the game physics, geometry, and other game-play details. If some aspect of the game can be visually identified in the dreamed trajectory, then that aspect of the game has been represented and generated by WHAM. Generally speaking, VQGAN provides higher output quality than VQAE when rated by human users.

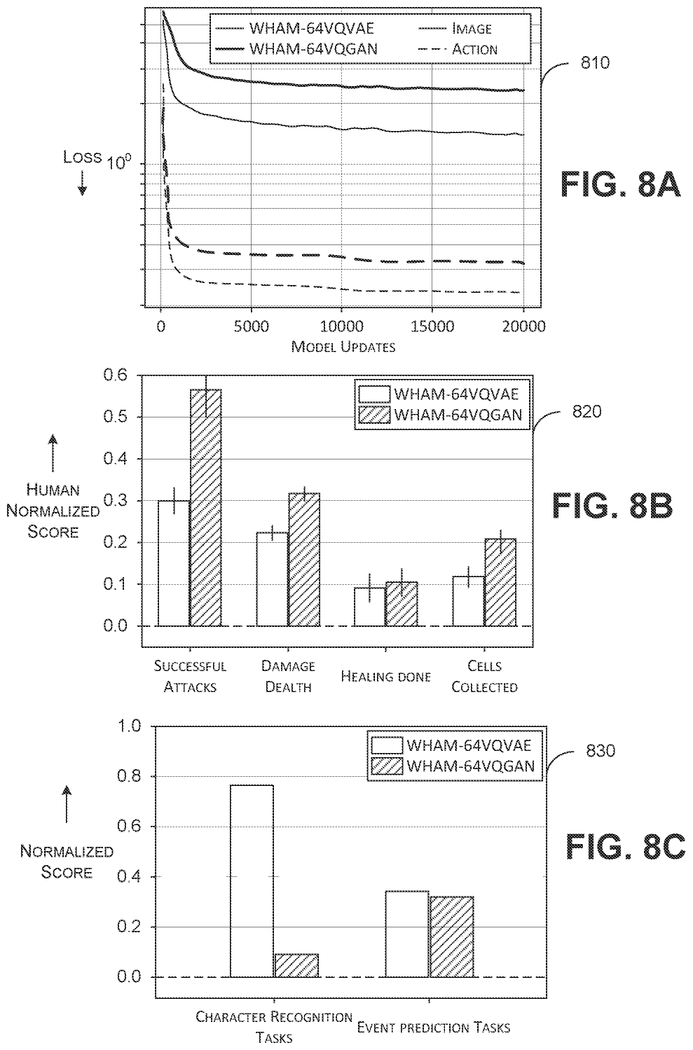

FIG. 8A shows a training loss graph 810, FIG. 8B shows a rollout performance graph 820, and FIG. 8C shows linear probe results graph 830, comparing the relative performance of using VQVAE vs. VQGAN as the encoder/decoder. These results show that the qualitative improvement in visual reconstruction by VQGAN indeed translates to improved model performance when rolled out online. This is true even though the action and image losses are slightly higher for VQGAN than for VQVAE. For example, this difference is particularly pronounced in terms of number of power cells collected.

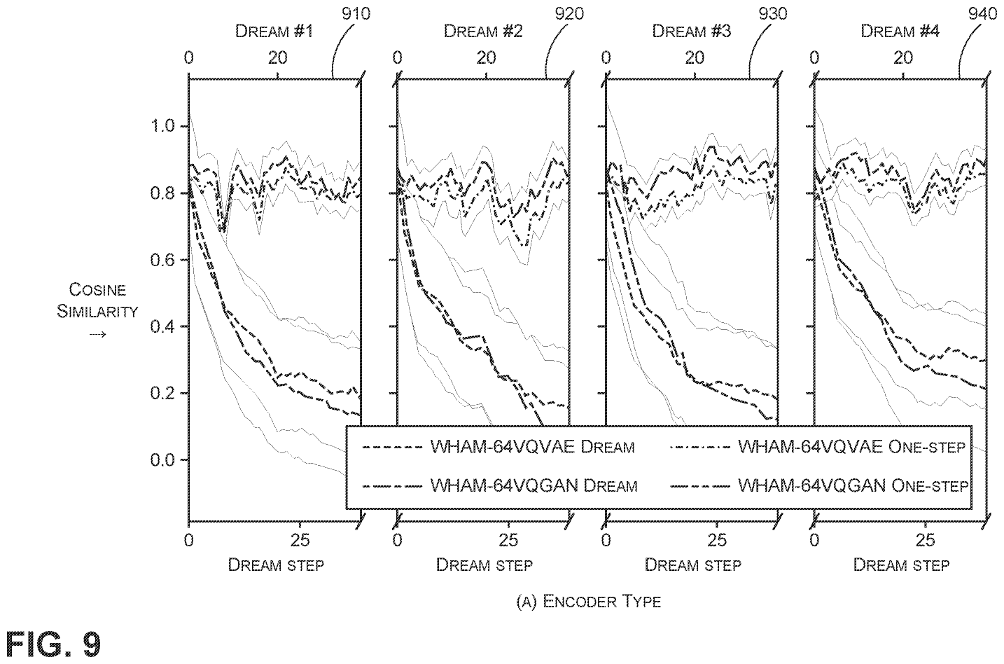

FIG. 9 shows dream results graphs 910, 920, 930, and 940, which compare the dreaming ability of the two models. The cosine similarity quantitative metric suggests that the dream quality of VQVAE and VQGAN is similar. However, from a qualitative perspective, there is a stark difference in image quality between the two. In particular, identifying the character is much easier for a human based on the VQGAN reconstructions compared to the VQVAE reconstructions.

However, FIG. 8C suggests that the model's internal representation is not linearly separable in terms of game-specific features, including the character identity. Therefore, it is likely that the additional discriminator in the decoder of VQGAN causes a qualitative visual benefit and quantitative improvement in ability to reproduce human behavior (FIG. 8B). Thus, VQGAN resulted in the highest performing model overall, even though its internal representation could not be interpreted via linear probing.

### Further Model Details

Encoder model details. Both VQGAN and VQVAE encoders take as input an image of size 128×128×3, and output codebook indices with latent vocab size of Vₒ=4096. The VQVAE encoder and decoder that were employed are adaptations of the code by Van Den Oord, et al., “Neural discrete representation learning,” Advances in neural information processing systems, 30, 2017. An additional convolutional layer in the encoder and decoder was added to reduce the bottleneck size to 64, and also add perceptual image loss to improve reconstruction quality (Zhang, et al., “The unreasonable effectiveness of deep features as a perceptual metric,” In Proceedings of the IEEE conference on computer vision and pattern recognition, pages 586-595, 2018). For training VQGAN models, the taming-transformers repository was employed (Esser, et al., “Taming transformers for high-resolution image synthesis,” In Proceedings of the IEEE/CVF conference on computer vision and pattern recognition, pages 12873-12883, 2021). Encoder/decoder training parameters are detailed in the following Table 1:

| Parameter | VQVAE | VQGAN |
|---|---|---|
| Num optimizer | 100,000 | 100,000 |
| updates | | |
| Learning rate | 0.0001 → 0.00001 | 0.00054 (4.5e−06*Batch |
| | | Size) |
| LR schedule | Cosine annealing | Constant with warmup |
| | with warmup | |
| Warmup steps | 500 | 1000 |
| Optimizer | AdamW | AdamW |
| Vocab size | 4096 | 4096 |
| Embedding | 512 | 512 |
| dimension | | |
| Batch size | 150 | 120 |
| Gradient clip | 1.0 | 1.0 |
| threshold | | |
| Discriminator Weight | N/A | 0.25 |
| GAN Loss Starting | N/A | 20,000 |
| Step | | |

Hyperparameters for the transformer training are described in Table 2 below:

| Parameter | Value |
|---|---|
| Num. optimizer updates | 20,000 |
| Num. timesteps trained | 160M |
| Learning rate | 0.0001 |
| LR schedule | Constant with warmup |
| Warmup steps | 1000 |
| Optimizer | AdamW |
| Weight decay | 0.0 |
| Gradient clip threshold | 1.0 |
| Num. transformer blocks | 16 |
| Num. attention heads | 16 |
| Transformer embedding size | 1024 |
| Parameter count | 208M |
| Control rate | 10 Hz |
| Context length in steps | 10 |
| Batch size | 800 |

For each run, a mini-batch size that fits into the V100's VRAM was employed, and gradient accumulation was adjusted to reach an effective batch size of 800.

### Tokenization Details

Separate tokens for images and actions were employed. For image encodings, the codebook indices from the VQ encoder were employed. For actions, each of the 16 dimensions was represented separately (12 for buttons, 4 for the discretized gamepad sticks). All tokens were then embedded using a single embedding layer.

The main training hyperparameters for the WHAM model are detailed above. The transformers employed the NanoGPT implementation. The selected model size (208M parameters) gave significant improvement in terms of training/validation loss over smaller models (10 blocks, 10 heads, 640 embedding size, 74M parameters), but not significantly worse than a larger one (18 blocks, 11 heads, 1408 embedding size, 500M parameters). FlashAttention was employed to speed up training as described in Dao et al., “Flashattention: Fast and memory efficient exact attention with io-awareness,” Advances in Neural Information Processing Systems, 35:16344-16359, 2022.

With a training context of 10 timesteps, 64 tokens for images and 16 tokens for actions, the final context length of the models is 800 tokens. After tokenizing the context, the cross-entropy loss of predicting the next token given all the previous ones was calculated, and the loss was averaged over the full token sequence. During inference, invalid tokens were masked for the current prediction step. For instance, when predicting an image token, action-related tokens were masked out.

For HAM models, the same setup was employed as for WHAM, but the prediction loss for image tokens was set to zero. To enable joint training of the encoder and transformer model, the previously-described setup was modified. Instead of using the codebook indices, a single linear layer that mapped the codebook vectors into transformer vectors was employed, effectively serving as an embedding layer but allowing backpropagation into the encoder. During joint training the encoder and decoder were also updated with the VQVAE's own reconstruction loss using the same batches. For actions, a separate trainable embedding layer was employed.

### Training Details

All models were trained using an Azure virtual machine cluster with 56 32 GB Nvidia V100 GPUs in total, distributed across 7 ND40rs-series nodes with 40 CPUs each and 671 GB RAM. The models were trained on either 8 GPUs at a time, over a period of 6 months, including all prototyping and hyperparameter search. Each WHAM/HAM model training took 5 to 7 days to complete, depending on the model settings.

Each WHAM/HAM model was trained for 20 k optimizer updates. With batch size of 800 and sequence length of 10 (one step is a single image and action), this corresponds to training for 160M timesteps. This is bit over half of an epoch over the training dataset (284M timesteps total).

### Example System

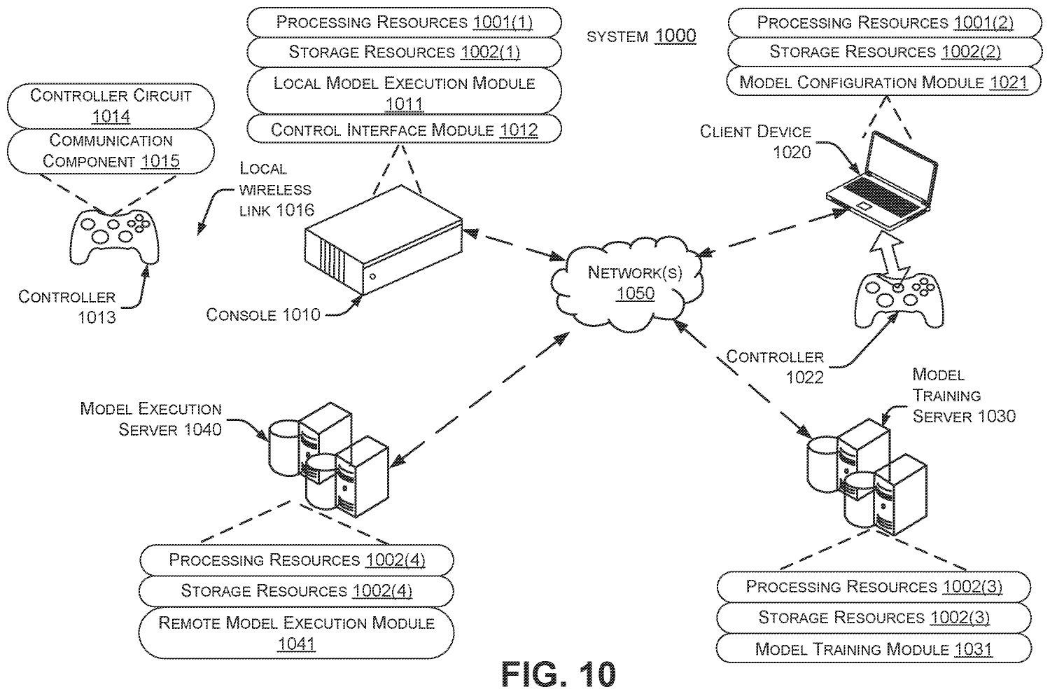

The present concepts can be implemented in various technical environments and on various devices. FIG. 10 shows an example system 1000 in which the present concepts can be employed, as discussed more below. As shown in FIG. 10, system 1000 includes a console 1010, a client device 1020, a model training server 1030, and a model execution server 1040. Console 1010, client device 1020, model training server 1030, and model execution server 1040 are connected over one or more networks 1050.

Certain components of the devices shown in FIG. 10 may be referred to herein by parenthetical reference numbers. For the purposes of the following description, the parenthetical (1) indicates an occurrence of a given component on console 1010, (2) indicates an occurrence of a given component on client device 1020, (3) indicates an occurrence on model training server 1030, and (4) indicates an occurrence on model execution server 1040. Unless identifying a specific instance of a given component, this document will refer generally to the components without the parenthetical.

Generally, the devices shown in FIG. 10 may have respective processing resources 1001 and storage resources 1002, which are discussed in more detail below. The devices may also have various modules that function using the processing and storage resources to perform the techniques discussed herein, as discussed more below.

The model training server 1030 can include a model training module 1031, which is configured to train one or more machine learning models as described elsewhere herein. For instance, the model training module can train an encoder/decoder model to encode/decode application outputs such as images, and a generative model such as a transformer to predict outputs and inputs. The model training server can distribute the trained model(s) to other devices in system 1000, e.g., console 1010 and/or model execution server 1040. Generally speaking, larger models that implement complex application behavior may tend to be implemented remotely via cloud resources, e.g., by running on remote model execution module 1041 on model execution server 1040. Conversely, smaller models that implement limited application behavior, such as relatively simple applications or limited parts of an application, may tend to be implemented locally on devices such as console 1010.

Console 1010 can include a local model execution module 1011 and a control interface module 1012. The local model execution module can obtain one or more trained machine learning models from model training server 1030 and execute the machine learning model(s) locally on the console. The control interface module 1012 can obtain control inputs from controller 1013, which can include a controller circuit 1014 and a communication component 1015. The controller circuit can digitize inputs received by various controller mechanisms such as buttons or analog input mechanisms. The communication component can communicate the digitized inputs to the console over the local wireless link 1016. The control interface module on the console can obtain the digitized inputs and send them to the local model execution module or to the model execution server 1040.

Client device 1020 can have a model configuration module 1021. The model configuration module can be employed to configure any aspect of model training and/or execution. For instance, the model configuration module can provide training data or hyperparameters to the model training server 1030, seed images for initiating dreaming or gameplay sequences to the console 1010 or model execution server 1040, etc. A second controller 1022 is additionally shown coupled to the client device 1020, e.g., via a wired or wireless link. The second controller 1022 is used in one example use case to generate inputs to a neural dreaming model, thus enabling the operation of the neural dreaming model to be controlled using the second controller 1022.

### Training Data Selection

Generally speaking, machine learning models can be taught various concepts by being exposed to sufficient training examples prior to being employed for inference. Given a large model with a sufficient number of training examples that show a wide range of concepts, it is possible to build a general-purpose generative model that learns generalized representations of inputs and outputs that can be employed effectively across a wider range of application scenarios. Thus, it can be useful to obtain training data for various scenarios, including outputs from many different types of applications and inputs provided by users with different abilities, demographic characteristics, etc.

For instance, consider video games. There are strategy games, shooting games, sports games, games where users control vehicles such as race cars or fighter planes, etc. In addition, there are games where users have a limited field of view, e.g., first person shooter games or a view out of the cockpit of a plane. There are other games where users see a top-down view of an entire playing surface, e.g., some soccer or football games. There are different ways that players can score points, get injured, heal damage, or obtain various in-game achievements. By exposing a generative model to a very wide range of games with different experiences, visuals, achievements, etc., a very general model can be developed. Then, the generative model will be able to generate plausible output and input sequences for a wide range of seed outputs.

In still further cases, a large generative model that has been trained using a wide range of training data from a variety of applications can be subsequently tuned to obtain a generative model that is adapted for specific types of games. For instance, a generative model could be trained on hundreds of games of various types, strategy, racing, fantasy, shooting, sports, etc. Then, that generative model could be further tuned using a specific subset of additional sports games to obtain a tuned generative sports model, tuned again on a specific subset of fantasy games to obtain a tuned generative fantasy model, etc. Then, seed outputs of example sports game scenarios could be input to the tuned generative sports model to implement various sports games, and seed outputs of example fantasy game scenarios could be input to the tuned generative fantasy model to implement various fantasy games.

In addition, user skill level, preferences, and other tendencies can vary widely. For instance, some users are very dedicated and skilled game players, whereas other users are novices. In addition, even two equally skilled game players may have very different tendencies, e.g., one might drive very aggressively and another might drive very carefully. By ensuring that the generative model sees sufficient training examples of varying user behaviors during training, the generative model can learn to generate input sequences that approximate those of a wider range of users.

### Output Sampling

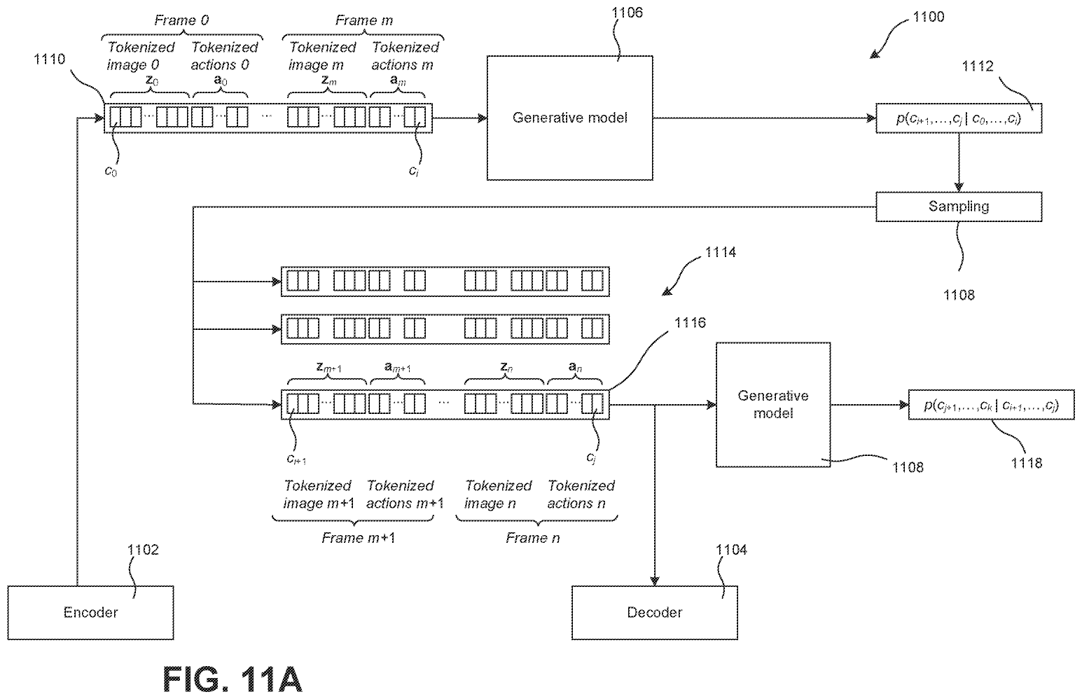

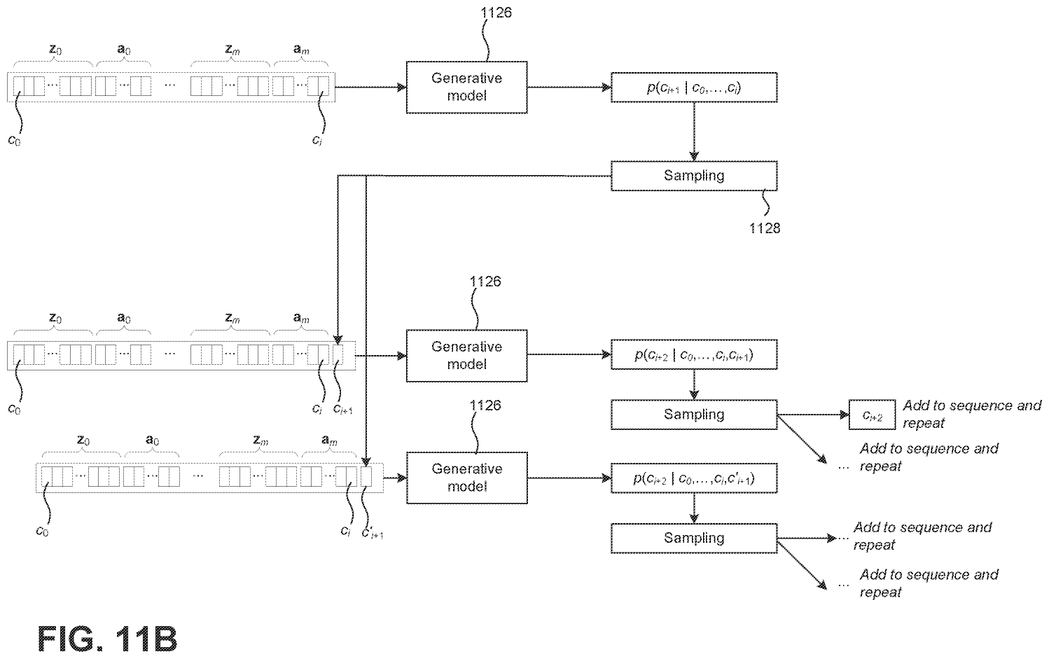

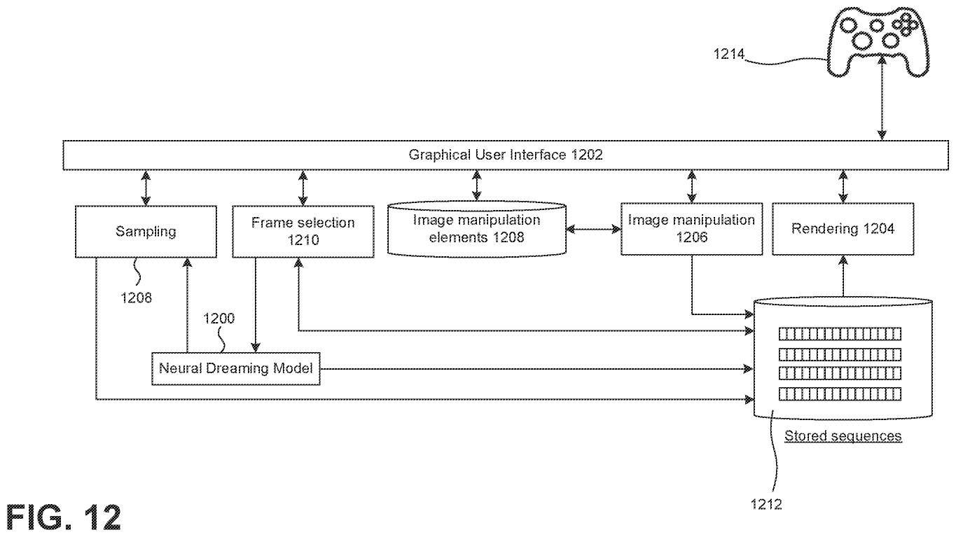

FIG. 11A shows a high-level conceptual block diagram of a probabilistic neural dreaming model 1100 comprising an encoder 1102, a decoder 1104 and a generative model 1106. The neural dreaming architecture described above may be used (in this case, the decoder 1104 and encoder 1102 are only applied to image tokens and images respectively, in the manner already described).

The generative model 1106 is configured to receive a first input sequence 1100 of interleaved observations tokens and actions tokens. The first input sequence 1100 is shown to comprise tokens c₀, . . . , cᵢ. Given the first input sequence 1110, (c₀, . . . , cᵢ), the generative model 1106 computes a first joint probability distribution 1112 over a next part of the sequence p(cᵢ₊₁, . . . , cⱼ|c₀, . . . , cᵢ), from token position i+1 to token position j. The first input sequence input sequence 1100 can be any length in principle. For some generative architectures, this subject to a constraint that a total length of the input sequence and the output sequence concatenated (j+1 in this example) is within a context window of the generative model 1106.

In the depicted example, the input sequence 1110 represents m+1 images (image 0 to image m) and i+1 controller states (action 0 to action m) where m can be any number including zero (image t and action t constitute frame t). This means a first subsequence of tokens zo represent a first image (image 0), followed by a second subsequence of tokens a₀ representing a first controller state (action 0), which together make up frame 0, and so on until frame m. However, in general, the first input sequence 1110 can terminate at any point; it may terminate with a complete or partial tokenized image, or with a complete or partial tokenized controller state. The generative model 116 probabilistically predicts the next part of the sequence commencing with the token position (i+1) immediately after the final token position (i) in the input sequence 1110. Hence, predicted token cᵢ₊₁ may be the first token of a new image (if the final token cᵢ in the input sequence is the final token of a controller state), the next token of a partially existing image (if token cᵢ is partway through an image), the initial token of a new controller state (if token cᵢ is the final token of an image), or the next token of a partially existing controller state (if token cᵢ partway through a controller state).

A sampling component 1108 enables one or multiple output sequences 1114 to be sampled from the joint distribution 1112. Multiple output sequences 1114 may be generated from the same input sequence 1110 though multiple sampling.

An output sequence (or part of an output sequence) may then be used to generate a second input sequence to the generative model 1108. By way of example, FIG. 1A shows a sequence 1116 which has been sampled from the joint distribution 1112, and which in turn becomes a second input sequence inputted to the generative model 1108, resulting in a second joint distribution 1118, (cⱼ₊₁, . . . , cₖ|cᵢ₊₁, . . . , cⱼ) over subsequent token positions j+1, . . . , k. In some cases, the second input sequence could additionally include all or part of the first input sequence 1110 concatenated with sequence 1116 (subject to any context window restriction).

FIG. 11B shows by way of example one possible implementation of the architecture of FIG. 11A based on next token prediction. FIG. 11B can be regarded as a special case of FIG. 11A with a generative model that, given an input sequence (c₀, . . . , cᵢ) predicts a probability distribution p(cᵢ₊₁|c₀, . . . , cᵢ) over the next token cᵢ₊₁ only. In this case, sampling component 1128 samples an individual token (or tokens) from p(cᵢ₊₁|c₀, . . . , cᵢ), to form a new input sequence (or sequences). In the depicted example, sampling component 1128 samples two tokens, cᵢ₊₁, cᵢ₊₁′, from p(cᵢ₊₁|c₀, . . . , cᵢ), and forms two new input sequences, (c₀, . . . , cᵢ, cᵢ₊₁) and (c₀, . . . , cᵢ, cᵢ₊₁′) by concatenating each of these with the original input sequence (c₀, . . . , cᵢ). Each of these new input sequences is, in turn, fed to the generative model, which generates distributions over the next token positions: p(cᵢ₊₂|c₀, . . . , cᵢ, cᵢ₊₁) and p(cᵢ₊₂|c₀, . . . , c, c₁₊₁). The process continues in the same manner (for example, if two alternative tokens were sampled from each of these distributions, that would result in four input sequences). Various ‘pruning’ mechanisms can be used to prevent exponential growth, ensuring that e.g. only the most probable output sequences are generated. Multiple samples can be generated in parallel on modern GPUs.

### Prototyping Use Case

The techniques described herein can be employed for a number of different use cases. For example, consider a rapid prototyping scenario where a developer wishes to evaluate how a new game idea might look and feel. The developer can obtain a few seed images for various points in the game and input the seed images into a trained generative model. The generative model can generate new sequences of outputs and inputs to show how game play might proceed when humans play the game.

One way to generate outputs and inputs involves a random sampling approach from output distributions provided by the generative model. Thus, for example, the generative model could output a probability distribution of (token A==0.7, token B==0.2 token C==0.1) for three future output or input tokens. A random number between 0 and 1 can be generated, and token A can be selected with a probability of 70%, token B with a probability of 20%, and token C with a probability of 10%. By executing the model several times, different generated gameplay sequences can be generated by the same model.

The developer can choose whether to keep or discard different sequences. For instance, referring back to FIG. 4A, assume the developer wishes to visualize how a racing game with a character riding a hoverboard might look. The trained generative model could output the sequences of outputs shown in FIGS. 4B-4D. If the developer likes the output, the developer could use those images for developing actual game code. If not, the developer could run the model again and generate a different sequence of images, e.g., perhaps with a sharper turn, fewer trees, a larger map inset, etc.

The developer could also choose to modify the seed image to obtain different generated sequences. For example, the developer might decide that a skateboard might be more realistic than a hoverboard, and replace the hoverboard shown in FIG. 4A with a skateboard. The generative model could then generate one or more new generated sequences where the character is riding a skateboard instead of a hoverboard. Or the developer could decide to use a narrower road, a different type of background (e.g., city buildings, etc.), insert an obstacle such as a boulder or another character on the road, etc. By modifying the seed image in this way, the developer can see how different sequences might play out for actual users if the game is implemented as generated by the model.

Certain user interface mechanisms to support such use cases will now be described.

FIG. 12 shows a schematic function block diagram of a frame generation system. A game design use case is considered below, in which frames comprise images and game controller states. However, the image generation system can be used in other contexts, including other forms of application design or prototyping.

The image generation system is shown to comprise a neural dreaming model 1200, a GUI 1202, a rendering component 1204, and image manipulation component 1206 that receives user-generated manipulation inputs, a set of predetermined image manipulation elements (e.g. contained in a database or library), a sampling component 1208 and a frame selection component 1210.

The neural drawing model 1200 and sampling component 1208 operate in the manner described above with reference to FIG. 11A. In some implementations, the neural drawing model 1200 and sampling component 1208 operate based on next token prediction in the manner described with reference to FIG. 11B.

Via the GUI 1202, a user can control the sampling (e.g. controlling a setting at the GUI 1202 that determines how many output tokens or sequences are sampled from a predicted output distribution) and frame selection (by selecting frame(s), image(s) or controller state(s) to include in an input sequence to the neural dreaming model 1200).

Frames generated by the neural dreaming model 1200 are stored in a frame storage repository 1212 (e.g. file, folder or database) and can be rendered on the GUI 1202 by the rendering component 1202.

The user can manipulate frames stored in the frame storage repository 1212, for example by adding image manipulation element(s) from the set of image manipulation elements 1208. Manipulated frames can, in turn, be selected via the GUI 1202 and fed back to the neural dreaming model 1200 to generate further frames.

In one example, the GUI 1202 is supported by a hardware game controller 1214 (of the kind used with modern gaming consoles). The hardware game controller 1214 can be used to manually define game controller states for inclusion in input sequences fed to the neural dreaming model 1200. Other hardware controllers can be used, e.g., Gamepad or Virtual Reality controllers.

Various user interface mechanisms which may be implemented in the system of FIG. 12 will now be described.

Frame sequences are considered below, where each frame comprises an image and a controller state, which is particularly relevant to game design, or other application design contexts where an application generates images dependent on controller input. However, in other use cases (such as synthetic video generation) each frame may be an image (without controller state).

### Branching Interface

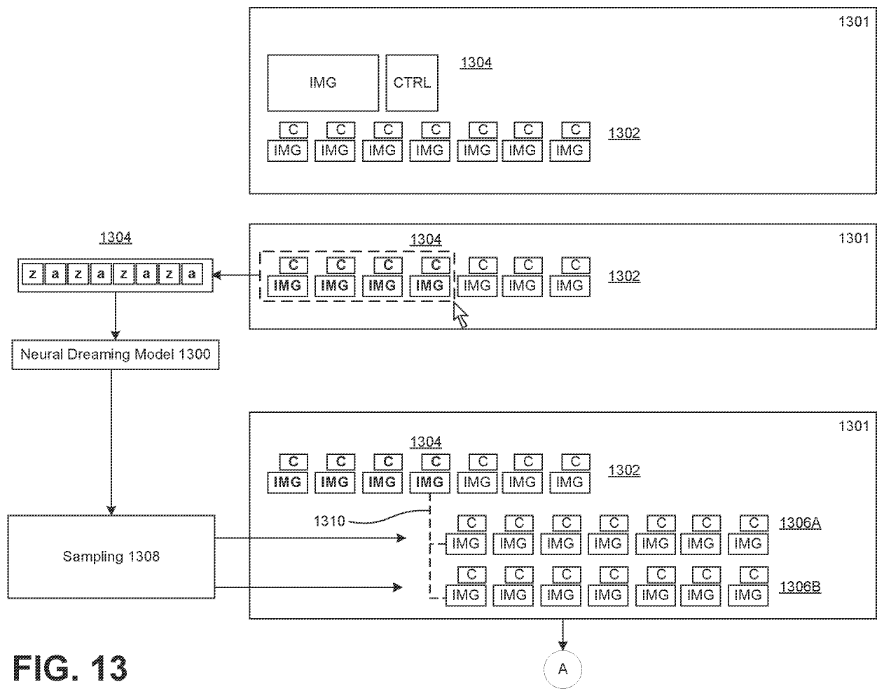

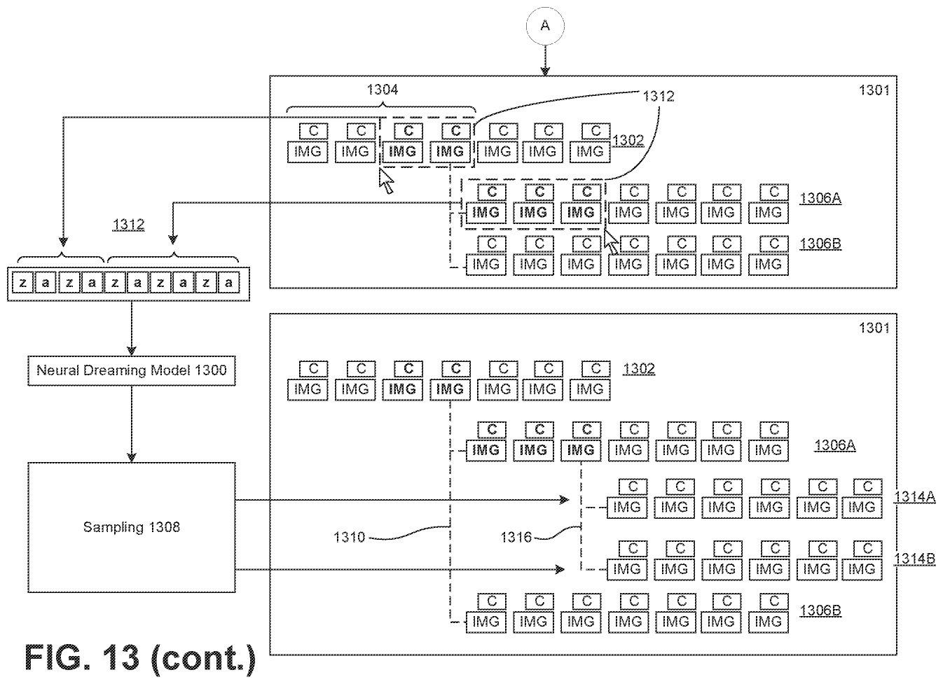

FIG. 13 schematically depicts a ‘branching’ view 1301 within a GUI supported by a neural dreaming model 1300 and sampling component 1308. A first frame sequence 1302 is shown. A preview part 1304 is shown, in which an enlarged rendering of an image and controller state of a selected frame is rendered. The first frame sequence 1302 may be a frame sequence generated by neural dreaming engine or a ‘seed’ sequence generated by some other mechanism.

Any subsequence within the first frame sequence can be selected via user input. In this example, a first selected subsequence 1304 is formed of an initial four frames 1304 of the first frame sequence 1302.

These frames of the first selected subsequence 1302 are tokenized in the manner described above, and fed to the neural dreaming model 1300 as an input sequence. The neural dreaming model 1300 predicts a probability distribution over a second part of the sequence immediately following the first selected subsequence 1302. The sampling component 1308 samples multiple subsequent sequences (first ‘candidate’ sequences) from the probability distribution, and renders those second candidate sequences within the branching view 1301. In this example, two second candidate sequences 1308A, 1306B are shown rendered within the branching view 1301. Those second candidate sequences 1308A, 1308B are said are said to branch from the first selected subsequence 1304 from which they have been generated. The second candidate sequences 1308A, 1308B may be described as ‘children’ of the first selected subsequence 1304 (their ‘parent’). In addition, a visual linking element 1310 is rendered, which visually links each second candidate sequence 1306A, 1306B with the first selected subsequence 1304 from which it branches. In this particular example, the visual liking element 1301 visibly connects the final frame of the first selected subsequence 1304 (parent) with the first frame of each second candidate sequence 1066A, 1306B (child).

In this particular example, the first frame sequence 1302 is made up of seven frames, only four of which were selected. The remaining three frames are not used when generating the second candidate subsequences 1306A, 1306B.

Further sequences can be generated in iterative manner, via free selection of further subsequences. In this particular example, a second subsequence 1312 is selected via user input, where the second selected subsequence is made up of the final two frames of the first subsequence 1304, together with the first three frames of second candidate subsequence 1306A. This illustrates a more general feature, namely the ability to define select (sub-)sequences that span multiple linked sequences. Note that only a sequence of second candidate subsequence 1306A is selected (its first three frames in this example). The rest of this sequence is not used in the subsequent generation.

The second subsequence 1312 is encoded and inputted to the neural dreaming model, which in turn generates a probability distribution over a third sequence immediately following the selected second subsequence 1312. Sampling component 1308 samples multiple candidate third sequences from this distribution. In this example, two third candidate sequences 1314A, 1314B are shown rendered within the branching view 1301, with a second liking element 1316 visually linking them back to their parent (to the final frame of the second subsequence 1312 in this example).

A user input may, for example, denote a portion of a first item sequence to be combined with a portion of a second item sequence to form a new input sequence, where a portion in this context could be a single item, some but not all items, or all items of the sequence in question. This approach enables portions of different sequins to be combined to form new input sequences that become new branches.

### Image Manipulation View

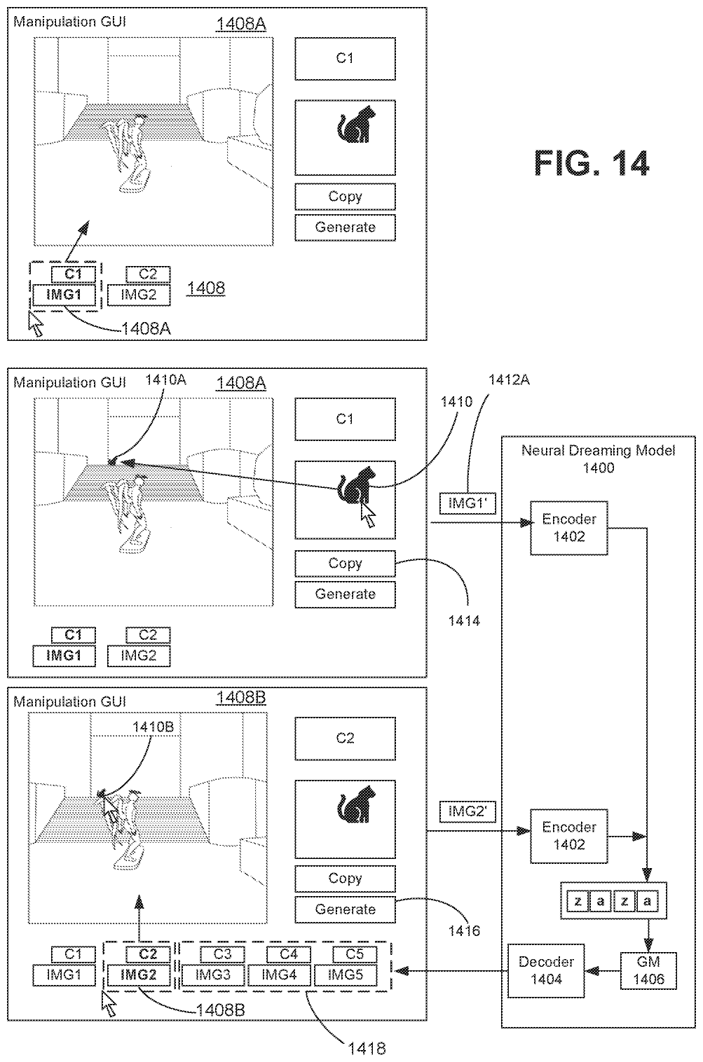

FIG. 14 shows an image manipulation view within a GUI supported by a neural dreaming model 1400. A first fame sequence 1408 is shown, which is a sequence of frames (two in this example) which have been generated by the neural dreaming model 1400. Initially, a user selected a first frame comprising a first image 1408A is rendered in an enlarged display area. A selectable manipulation element 1410 is displayed, which might for example be a visual ‘template’ for a game character or object. A first instance 1410A of the manipulation element 1410 is created via a first selection input associated with the manipulation element 1410 (one example of a user-generated manipulation input), and can be located and sized within the first image 1408A via further user input. Based on the first image 1408A and the first instance 1410A of the manipulation element 1410, a manipulated first image 1412A is created. This manipulated first image 1412A can now be fed as input back to the neural dreaming model 1400, causing it to generate subsequent frame(s) based on the manipulated version of its own previous outputs.

However, it can be beneficial to manipulate multiple sequential frames in this manner, as this enables a desired dynamic property or properties to be conveyed to the neural dreaming model 1400.

To enable easy manipulation of subsequent frame(s), a selectable ‘copy-to-next frame’ element is displayed. With a single user input, the GUI can be progressed to the next frame, which additionally copying the image manipulation element(s) added to the first image 1408A can be automatically duplicated to a second image 1408B of the next frame. In this case, in response to such a user input, the second image 1408B is displayed within the enlarged view, together with a second instance 1410B of the manipulation elements 1410 that is automatically created. This, in turn, can be re-located/resized via further user input, for example to convert motion of this element between the first image 1408A and the second image 1408B. Based on the second image 1408B and the second instance 1410B of the manipulation element 1410, a manipulated second image 1412B is created.

A generate option is displayed 1416, which is selectable to cause the manipulated images 1412A, 1412B to be encoded (by encoder 1402) and sequenced, and inputted to generative model 1406, resulting in an output sequence 1418 that is decoded (by decoder 1404) and rendered in the image manipulation view. This output sequence 1418 is a frame sequence that is predicted to come immediately after the first and second frames taking into account the manipulations of those frames.

As indicated, the manipulations can be relatively ‘crude’, as these merely serve as a steer to the neural dreaming model 1400. A game developer need not concern themselves with trying to match the aesthetics of the game, or any manipulation of the images to account for the manipulation, as all of those aspects are handled by the neural dreaming model 1400. For example, if a character template was added to those images, the subsequent frames are likely to include a new, similar character, but more aligned with the aesthetics of the game frames, and with other elements of the game adapted appropriately (e.g. a player character might be seen to reach to the new character in the subsequent frames 1418).

Once the subsequent frames 1418 have been generated, the earlier manipulations can be discarded.

If not properly used, this approach can lead to discrepancies, such as a character suddenly appearing out of nowhere, e.g. if the image manipulation element 1410 is placed at random in the image. However, this is easily addressed by appropriate placement of the image manipulation element (e.g. placing a character template near to the edge of a frame, or close a door from which it then emerges).

### Game Controller Inputs

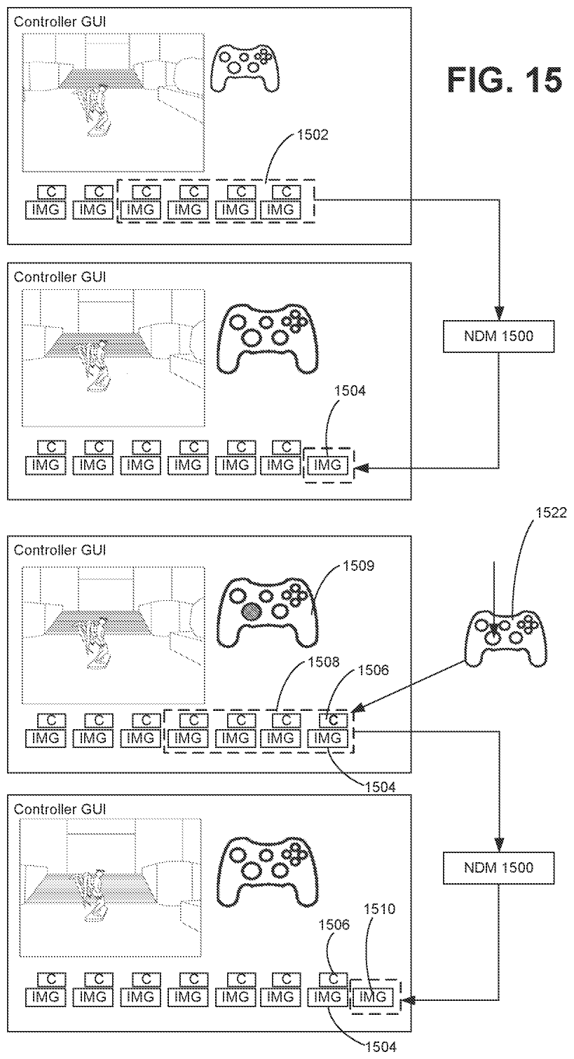

FIG. 15 shows an example setup, in which user control inputs (received at a game controller 1522 in this example) are used in generating input sequences to a neural dreaming model 1500. In some embodiments, the game controller 1522 is a dedicated hardware game controller, enabling a designer to generate new game frames (e.g., frame-by-frame) though inputs to the hardware game controller just as if they were playing an actual game. This provides a more intuitive, tactile and ergonomic game design experience. In other embodiments, the game controller 1522 may be a virtual game controller.

A first frame sequence 1502 is shown, which is inputted to neural dreaming model 1500 resulting in a generated second image 1504 for a next frame. Each frame in the first frame sequence 1502 comprises a first image and a first controller state. It is not necessary to generate a game controller state for the next frame, because a user-defined controller state will be used in the subsequent step.

Having generated the second image 508, a user input at the controller 1522 (such as pressing a button, manipulating a joystick, simultaneously pressing multiple buttons, or simultaneously pressing a button and manipulating a joystick etc.) causes a second controller state 1508 to be generated. Hence, a full second frame is formed of the second image 1504 generated by the neural dreaming model 1500 and the user-defined second controller state 1506.

A second input sequence 1508 is then inputted to neural dreaming model 1500. The final frame of the second input sequence 1508 if the second frame made up of the previously generated image 1504 and the user-defined second controller state 1506. In this example, the second frame is preceded by the final three frames of the first input sequence 1502.

In one embodiment, the second input sequence 1508 is inputted to the neural dreaming model 1500 automatically, in response to the same user input at the controller 1522 that caused the second controller state 1506 to be generated. This, a single user input at the game controller 1522 automatically progresses the overall sequence by one frame.

The result is a third image 1510 for a third frame immediately following the second frame. This process can be repeated, with a further user input at the controller to define a third controller state, causing a fourth image for a fourth frame to be automatically generated, and so on.

In all of the above examples described with reference to FIGS. 13-15, at the end of the process, a final frame sequence can be generated and outputted for subsequent implementation. For example, final frame sequence may be stored in persistent storage, transmitted via a network or transferred to another device or application for use in a next stage of game or application development.

Note that the various frame generation mechanisms of FIGS. 13-15 can be combined in any combination, e.g. within the frame generation system of FIG. 12. For example, branching may be combined with image manipulation, and controller-based input may similarly be combined with image manipulation. Similarly, controller-based input may be used to generate different candidate sequences within a branching interface.

The techniques can also be extended to other content modalities, such as audio content, haptic content etc. In this case, a content item may take the form of an image, a gameplay frame, a set of audio data. For example audio content items may be sequenced in a music or speech synthesis tool. A content item may be multi model, e.g. comprising text and image. With audio, an audio item may be rendered visually (e.g. as a waveform, frequency spectrum or simply a ‘generic’ audio icon or using some other indication that may or may not be dependent on the audio content) and/or outputted via an audio-based user interface (such as a loudspeaker). A content item could alternatively or additionally comprise program code. For example, code items may be sequenced to build a more complex program. A frame, image or other content item may be rendered as a visual rendering of its content or as some other visual indication of the content item not necessarily dependent on its content. In text synthesis, literary content may be generated with alternative narrative ‘branches' that can be explored and selectively extended.

For example, in one embodiment, a generative model us used to generate at least two branches from one seed content item (e.g. image, audio, code etc.). A user interface receives a seed content item selection (e.g., an image and/or other multimodal content) and optionally other parameter(s) about a desired output item. An input to the generative model is created based on the seed content item (and other parameter(s) if applicable). At least two alternative content items are received in response (e.g., multiple sequences of video frames), and outputted (e.g., via an editing user interface). In some implementations, a new parameter (e.g., new game character, game controller input, etc.) can be injected to further guide the process.

More generally, the described techniques can be applied to any generated outputs, e.g. to create or manipulate branches of generative model output (e.g., synthesized code, simulated or actual industrial outputs and/or other applications, engineering data, cybersecurity data, such as simulated cyberattack outputs used to identify and mitigate security issues with systems though appropriate security mitigation actions). The described techniques have general application to sequence-based generative models, in which alternative sequences of generated outputs can be generated, and new branches generated by selecting subsequences of such generated sequences and/or combining parts from different sequences as further inputs.

### Application Execution Use Case

In further implementations, one or more seed outputs can be employed to cause the trained generative model to replace part or all of a hand-coded application. For instance, as noted above, inputs generated by the model can be discarded, and instead inputs received from an actual user can be used by the model to predict future output sequences. Thus, the generative model itself can serve directly as the application.

In some cases, the generative model can serve as an entire application, e.g., all application output is generated by the model. In other cases, the generative model can implement some of the application functionality and other parts of an application can be hand-coded. For instance, consider a scenario where a client-side device is relatively resource constrained and can execute a relatively small generative model. The generative model might perform well for about 100 milliseconds of predicting application output, but thereafter might tend to diverge substantially from realistic outputs. Such a generative model could still be useful to address issues such as network disruptions.

Referring back to FIG. 10, a small generative model could be provided to the console 1010. During normal network conditions, the remote model execution module 1041 could receive user inputs from the console over network 1050, and provide application output to the console over the network. When a network disruption is detected that delays one or more packets longer than a threshold (e.g., 100 milliseconds), the local model execution module 1011 on the console can temporarily take over and provide output to the user using the small generative model.

As another example, certain portions of a given application could be executed within a conventional game engine or hand-coded logic, while other portions are executed using a trained generative model. For instance, a trained generative model could be employed for actually racing on a racetrack during a racing game, but the initial countdown to starting the race and maintaining of a leaderboard with race results could be implemented within a game engine or using hand-coded logic. As another example, a flight simulator might use a trained generative model to control the flight pattern of a virtual aircraft, but weapons functionality could be implemented in an application engine to give the developer full control over weapons functionality.

There are various techniques that could be employed to obtain a smaller generative model suitable for client-side execution. For instance, a full-scale generative model that generalizes to a wide range of games could be trained and deployed on model execution server 1040. That model could be pruned to remove nodes or weights that do not significantly contribute to model performance for specific client-side scenarios. For instance, pruning could be performed on an application-specific basis, e.g., removing nodes or weights that do not significantly affect performance of the model for a specific application. Alternatively or in addition, distillation techniques could be employed to teach a smaller student generative model to learn from the output distribution of a larger teacher model over a limited range of scenarios. Generative models obtained via pruning or distillation may offer adequate performance for limited (e.g., short-duration) client-side execution scenarios. As yet another example, for applications with relatively simple characteristics, e.g., simply logic rules, relatively simple graphics, etc., a smaller stand-alone generative model can be trained for scratch specifically for that application.

### Further Implementations

In addition to video output, other types of application output can also be generated. For instance, audio and/or haptic output can be encoded using an encoder/decoder model, and corresponding audio or haptic output tokens can be used to train a generative model to predict audio or haptic output by an application.

In other cases, a generative model can be trained using tokens representing individual users. Thus, the generative model can learn how different types of users have different abilities, tendencies, preferences, etc. When the trained model is executed for a new user, a token representing that user can be learned. Then, the outputs (and inputs) generated by the generative model can be conditioned not only on the previous outputs and inputs, but also the token representing the user that is playing the game. Thus, that user can receive an experience that is tailored to their own characteristics or preferences.

In addition, note that the encoder/decoder and generative model architectures and training techniques described above are examples, and other types of models and/or training techniques can also be employed. For instance, token prediction training can be performed bidirectionally, e.g., by masking out individual output or input tokens from a training sequence and training the generative model to predict both preceding and subsequent tokens. As another example, a long short-term memory model can be employed instead of a transformer for generating inputs and outputs. Still further, an encoder/decoder model approach could be employed for representing user inputs instead of directly mapping input mechanisms to specific bits or other values, as discussed previously.

In addition, note that some implementations may employ a text-to-image synthesis model to generate seed outputs. For instance, instead of feeding a model a picture of a troll fighting a dragon, a developer could ask a text-to-image synthesis model to automatically generate a picture of a troll fighting a dragon. The image produced by the text-to-image synthesis model could be used as a seed input for prototyping or direct gameplay.

In some cases, the developer could provide individual game checkpoints via example outputs. For instance, the developer could provide an image of a character at a first location on a path through the woods, a second image of the character on a boat, a third image of the character on an airplane, and so on. Then, the developer could have the generative model generate a sequence for each example image, so that the gameplay experience for the user would involve traveling through the woods, getting on a boat, and then getting on an airplane.

In addition, note that the disclosed techniques can also be employed for augmented or virtual reality experiences. Consider a generative model that is trained on a videoconferencing application of participants co-located in conference rooms and also of remote participants working from home. A trained generative model could be employed to patch together images from multiple home offices to create an experience that appears as if the users are all co-located in the same conference room.

### Technical Effect

As noted above, the disclosed techniques can be employed to train a generative model that jointly learns to predict application outputs and user inputs. As a consequence, the trained generative model can generate plausible sequences of outputs and/or inputs for various use cases, such as rapid prototyping or executing the generative model directly as an application.

Prior techniques such as behavioral cloning or world modeling have limitations that are overcome by the present techniques. For instance, while behavioral cloning techniques can reasonably approximate human inputs to an application, the application itself needs to be developed to train and utilize these techniques. Conversely, while world modeling can predict how an application might behave in response to user inputs, the user inputs need to be obtained separately.

Because the disclosed techniques can generate both application output and user inputs, the disclosed techniques can generate future trajectories without a separate application or source of user inputs. Moreover, unlike some prior predictive techniques that require internal state information such as the location of different characters, the disclosed techniques can be implemented without accessing any internal application state.

In addition, as noted previously, some implementations can train the encoder/decoder and generative models separately. This is more efficient than joint training and can save a great deal of processor and/or memory resources that would otherwise be expended during joint training.

### Example Training Method

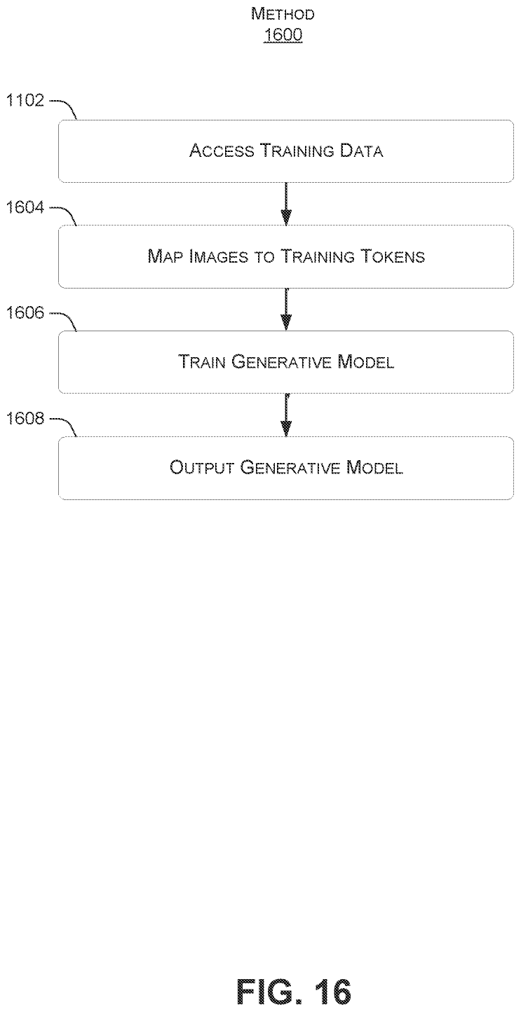

FIG. 16 illustrates an example method 1600 that can be used to train a model to predict application outputs and inputs, consistent with the present concepts. As discussed elsewhere herein, method 1600 can be implemented on many different types of devices, e.g., by one or more cloud servers, by a client device such as a laptop, tablet, or smartphone, or by combinations of one or more servers, client devices, etc.

Method 1600 begins at block 1602, where training data is accessed. For instance, the training data can include training sequences of images or other application outputs of the one or more applications and inputs provided to the one or more applications during the one or more executions. In some cases, the applications are interactive applications, such as video games, flight simulators, etc.

Method 1600 continues at block 1604, where the images are mapped to training image tokens. For instance, a trained image encoder/decoder can be employed to map the images to tokens, e.g., embeddings in a vector space. Other types of application output (e.g., audio or haptic) in the training sequences can also be mapped to corresponding tokens. In addition, inputs in the training sequences can be mapped to training input tokens, e.g., by representing different input mechanisms as different bits or other values in the training input tokens.

Method 1600 continues at block 1606, where a generative machine learning model (such as a transformer-based neural dreaming model) is trained to predict the training image tokens and the training input tokens that are obtained from the training sequences. For instance, in some cases, the generative machine learning model is a transformer that is trained to predict sequences of tokens representing the inputs and outputs. Block 1604 can also involve separate or joint training of an encoder/decoder model to generate tokens representing the outputs.

Method 1600 continues at block 1608, where the trained generative machine learning model is output. For instance, the generative model can be output to storage, shared in memory with another process or thread, or sent over a network to a separate device for later execution.

### Example Inference Method

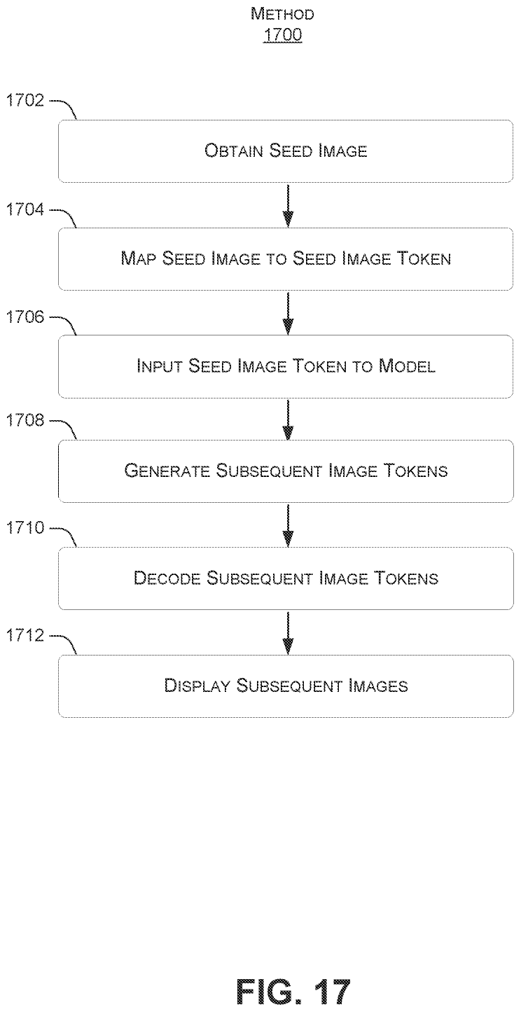

FIG. 17 illustrates an example method 1700 that can be used to generate application outputs and inputs with a trained generative machine learning model, consistent with the present concepts. As discussed elsewhere herein, method 1700 can be implemented on many different types of devices, e.g., by one or more cloud servers, by a client device such as a laptop, tablet, or smartphone, or by combinations of one or more servers, client devices, etc.

Method 1700 begins at block 1702, where a seed image is obtained. For instance, the seed image can be an image representing a starting point for an application scenario, e.g., a seeded application state. Other types of seed output (e.g., audio or haptic) can also be obtained at block 1702. In some cases, a seed input representing a user input responsive to the seed image can also be obtained at block 1702.

Method 1700 continues at block 1704, where the seed image is mapped to at least one seed image token using an encoder. For instance, as noted above, the encoder can be part of an image encoder/decoder that has been trained to represent images in vector space using training images. The encoder can have been trained using reconstruction loss. Other types of seed output obtained at block 1702 can also be mapped into corresponding tokens.

Method 1700 continues at block 1706, where the at least one seed image token is input as a prompt to a generative machine learning model, such as a neural dreaming model. For instance, the generative machine learning model can have previously been trained to predict application outputs (e.g., image, audio, and/or haptic) and inputs that are present in training sequences obtained from one or more executions of one or more applications. For instance, the generative machine learning model can include one or more transformer decoder blocks.

Method 1700 continues at block 1708, where subsequent image tokens are generated. For instance, the subsequent image tokens can be sampled randomly from an output distribution of the generative machine learning model. Audio and/or haptic tokens can also be generated at block 1708. In some cases, input tokens are also selected from the output distribution. In other cases, inputs are received from a user and the output distribution of the model for inputs is discarded.

Method 1700 continues at block 1710, where the subsequent image tokens are decoded using an image decoder, e.g., from the image encoder/decoder employed at block 1704. The decoded image tokens can be images in an image space. Audio and/or haptic tokens can also be decoded at block 1708.

Method 1700 continues at block 1712, where the subsequent images are displayed. Decoded audio and/or haptic tokens can also be output at block 1710, e.g. by playing audio over a speaker and/or causing a video game controller or other device to generate haptic feedback.

### Device Implementations

As noted above with respect to FIG. 10, system 1000 includes several devices, including a console 1010, a controller 1013, a client device 1020, a model training server 1030, and a model execution server 1040. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 1050. Without limitation, network(s) 1050 can include one or more local area networks (LANs), wide area networks (WANs), the Internet, and the like.

### Additional Examples

Various examples are described above. Additional examples are described below. One example includes a method comprising obtaining a seed image representing a seeded application state, mapping the seed image to at least one seed image token using an image encoder, inputting the at least one seed image token as a prompt to a neural dreaming model that has been trained to predict training sequences obtained from one or more executions of one or more applications, the training sequences including images output by the one or more applications during the one or more executions and inputs to the one or more applications during the one or more executions, generating subsequent image tokens with the neural dreaming model, and decoding the subsequent image tokens with an image decoder to obtain subsequent images.

Another example can include any of the above and/or below examples where the neural dreaming model comprises a transformer decoder.

Another example can include any of the above and/or below examples where the neural dreaming model is a multi-modal model and the generating also involves generating subsequent input tokens.

Another example can include any of the above and/or below examples where the method further comprises sequentially generating further subsequent image tokens and further subsequent input tokens with the neural dreaming model conditioned on previously-generated image tokens and previously-generated input tokens.

Another example can include any of the above and/or below examples where the method further comprises receiving actual user input tokens representing actual user inputs, inputting the actual user input tokens to the neural dreaming model, and generating the subsequent image tokens based at least on the actual user inputs.

Another example can include any of the above and/or below examples where the method further comprises sequentially generating further subsequent image tokens with the neural dreaming model conditioned on previously-generated image tokens and previously-received actual user input tokens.

Another example can include any of the above and/or below examples where the neural dreaming model has been trained using token prediction loss when predicting image tokens and input tokens from the training sequences.

Another example can include any of the above and/or below examples where the image encoder and the image decoder have been trained using reconstruction loss from the images in the training sequences.

Another example can include any of the above and/or below examples where the method further comprises displaying the subsequent images.

Another example can include a system comprising a hardware processing unit and a storage resource storing computer-readable instructions which, when executed by the hardware processing unit, cause the hardware processing unit to obtain a seed image representing a seeded application state, map the seed image to at least one seed image token, input the at least one seed image token as a prompt to a generative model that has been trained to predict image tokens and input tokens of training sequences obtained from one or more executions of one or more applications, and generate subsequent image tokens with the generative model.

Another example can include any of the above and/or below examples where the seed image represents output by a video game that is at least partially implemented by the generative model.

Another example can include any of the above and/or below examples where the generative model has been trained to predict images output by video games and video game controller inputs that are present in the training sequences.

Another example can include any of the above and/or below examples where the computer-readable instructions, when executed by the hardware processing unit, cause the hardware processing unit to map the seed image to the at least one seed image token using an image encoder.

Another example can include any of the above and/or below examples where the image encoder having been trained using reconstruction loss from the image tokens in the training sequences and the generative model having been trained using token prediction loss when predicting the image tokens and the input tokens in the training sequences.

Another example can include any of the above and/or below examples where the input tokens obtained from the training sequences have values representing different input mechanisms of a video game controller.

Another example can include any of the above and/or below examples where the computer-readable instructions, when executed by the hardware processing unit, cause the hardware processing unit to generate future image tokens and future input tokens given past image tokens produced by the generative model and past input tokens produced by the generative model.

A first example aspect is directed to a computer-implemented method comprising: receiving a first item; outputting the first item; inputting the first item to a generative model; receiving from the generative model, in response to the first item, multiple candidate second items; outputting each candidate second item; receiving user input denoting a second item of the multiple candidate second items; based on the user input, inputting the second item to the generative model; receiving from the generative model, in response to the second item, a third item; and outputting the third item.

In some example embodiments, the first item may form part of a first item sequence inputted to the generative model, the first item sequence comprising multiple first items.

Multiple candidate second item sequences may be received from the generative model, each comprising multiple second items, and the second item may form part of a second item sequence of the multiple second candidate item sequences.

The user input may denote one or some but not all second items of the second item sequence, wherein based on the user input said one or some but not all second items are inputted to the generative model. Alternatively, the user input may denote all candidate second items of the second candidate item sequence.

Alternatively or additionally, the user input may denote the second item and the first item. Based on the user input, the second item and the first item may be inputted to the generative model, the third item being received in response thereto.

For example, where the first item forms part of a first item sequence, the user input may denote the second item of the second item sequence and: the first item of the first item sequence, or a further first item of the first item sequence. Based on the user input, the second item and the first item or the further first item may be inputted to the generative model, the third item being received in response thereto.

Outputting the first item may comprise rendering the first item in a graphical user interface (GUI). Outputting each candidate second item may comprise rendering each candidate second item in the GUI with a first visual linking element that visually links each candidate second item with the first item.

Multiple candidate third items may be received from the generative model in response to the second item, and the method may comprise rendering each candidate third item in the GUI with a second visual linking element that visually links each candidate third item sequence with the second item.

The method may comprise causing to be performed based on the third item an industrial machine action, a vehicle manipulation action, a security mitigation action, a machine repair or maintenance operation, or another physical action.

A second example aspect provides a computer-implemented method, comprising: receiving from a generative model a generated item; outputting the generated item; receiving a manipulation input associated with the generated item; creating a manipulated item based on the generated item and the manipulation input; inputting the manipulated item to the generative model; receiving from the generative model a further generated item in response to the manipulated first item; and outputting the further generated item.

In some example embodiments, the method may comprise receiving from the generative model a second generated item; outputting the second generated item; receiving a second manipulation input associated with the second generated item; creating a second manipulated item based on the second generated item and the second image manipulation input. An item sequence comprising the manipulated item and the second manipulated item may be inputted to the generative model, and the further generated item may be received in response to the item sequence.

The further generated item may form part of a further item sequence comprising multiple further generated items, and the further item sequence may be received from the generative model in response to the item sequence.

The generated item and the second generated item may form part of a generated item sequence.

The method may comprise receiving a seed item; and inputting the seed item to the generative model, resulting in the generated item.

The generated item may be one of multiple candidate generated items received from the generative model, wherein each candidate generated item is outputted. Such embodiments may be combined with the method of the first aspect or any embodiment therefore, with the ability to select from different candidate item, manipulate the selected candidate item(s) if desired, and feedback the (manipulated or unmanipulated) items to generate further outputs.

A third example aspect provides a computer-implemented method comprising: receiving from a generative model a first generated item; outputting the first generated item via a user interface (UI); receiving a first user control input; determining a first controller state based on the first user control input; inputting to a generative model the first generated item and the first controller state; receiving from the generative model a generated second item generated based on the first generated item and the first controller state; and rendering the second generated item in the UI.

In some example embodiments, the method may comprise receiving a second user control input; determining a second controller state based on the second user control input; inputting to the generative model the second generated item and the second controller state; receiving from the generative model a generated third content generated based on the second generated item and the second controller state; and outputting the third generated item via the UI.

The first user control input may be received via a hardware game controller.

The UI may be a graphical user interface.

A further example provides a computer system, comprising a processor and a memory coupled to the processor, the memory storing computer-readable instructions configured, when executed by the processor, to implement the method of any above aspect or embodiment.

A further example provides a computer-readable storage medium storing computer-readable instructions configured, when executed by a processor, to implement the method of any above aspect or embodiment.

Another example can include any of the above and/or below examples where the computer-readable instructions, when executed by the hardware processing unit, cause the hardware processing unit to generate future image tokens given past image tokens produced by the generative model and actual user inputs received from a video game controller.

Another example can include any of the above and/or below examples where the computer-readable instructions, when executed by the hardware processing unit, cause the hardware processing unit to receive a natural language description of an application scenario and generate the seed image from the natural language description using a text-to-image synthesis model.

Another example can include a computer-readable storage medium storing computer-readable instructions which, when executed by a hardware processing unit, cause the hardware processing unit to perform acts comprising accessing training data reflecting one or more executions of one or more applications, the training data including training sequences of images output by the one or more applications and inputs provided to the one or more applications during the one or more executions, mapping the images to training image tokens and the inputs to training input tokens, training a generative model to predict the training image tokens and the training input tokens sequentially according to the training sequences, and outputting the trained generative model.

Another example can include any of the above and/or below examples where the acts further comprise training an image encoder/decoder to map the images in the training sequences to the training image tokens using reconstruction loss and training the generative model using next token prediction loss for the training image tokens and the training input tokens.

Another example can include a method comprising accessing training data reflecting one or more executions of one or more applications, the training data including training sequences of application outputs of the one or more applications and inputs provided to the one or more applications during the one or more executions, training a predictive model to predict the application outputs and the inputs that are present in the training sequences, and outputting the trained predictive model.

Another example can include any of the above and/or below examples where the training comprises sequentially predicting future application outputs and future inputs given past application outputs and past inputs that are present in the training sequences.

Another example can include any of the above and/or below examples where the predictive model comprises a neural network.

Another example can include any of the above and/or below examples where the predictive model comprises a transformer.

Another example can include any of the above and/or below examples where the method further comprises determining past output tokens representing past application outputs in the training sequences and past input tokens representing past inputs in the training sequences and training the predictive model to predict future application output tokens and future input tokens given the past output tokens and the past input tokens.

Another example can include any of the above and/or below examples where the application outputs include images output by the one or more applications during the one or more executions.

Another example can include any of the above and/or below examples where the method further comprises mapping the images into the past output tokens using another machine learning model.

Another example can include any of the above and/or below examples where the another machine learning model comprises an image encoder/decoder.

Another example can include any of the above and/or below examples where the method further comprises training the image encoder/decoder using reconstruction loss for the images.

Another example can include any of the above and/or below examples where the application is a video game.

Another example can include any of the above and/or below examples where the inputs in the training sequences are provided by a video game controller.

Another example can include any of the above and/or below examples where the method further comprises representing respective input mechanisms of the video game controller as corresponding bits in the past input tokens and the future input tokens.

Another example can include a system comprising a hardware processing unit and a storage resource storing computer-readable instructions which, when executed by the hardware processing unit, cause the hardware processing unit to obtain a seed application output, input the seed application output to a predictive model that has been trained to predict application outputs and inputs that are present in training sequences obtained from one or more executions of one or more applications, and generate subsequent application outputs with the predictive model.

Another example can include any of the above and/or below examples where the computer-readable instructions, when executed by the hardware processing unit, cause the hardware processing unit to, starting from the seed application output, sequentially generate the subsequent application outputs and subsequent application inputs with the predictive model.

Another example can include any of the above and/or below examples where the computer-readable instructions, when executed by the hardware processing unit, cause the hardware processing unit to sequentially generate further subsequent application outputs and further subsequent application inputs with the predictive model, conditioned on previously-generated application outputs and previously-generated application inputs.

Another example can include any of the above and/or below examples where the computer-readable instructions, when executed by the hardware processing unit, cause the hardware processing unit to receive actual user inputs, input the actual user inputs to the predictive model, and generate the subsequent application outputs based at least on the actual user inputs.

Another example can include any of the above and/or below examples where the computer-readable instructions, when executed by the hardware processing unit, cause the hardware processing unit to sequentially generate further subsequent application outputs with the predictive model conditioned on previously-generated application outputs and previously-received actual user inputs.

Another example can include any of the above and/or below examples where the computer-readable instructions, when executed by the hardware processing unit, cause the hardware processing unit to receive a natural language description of an application scenario and generate the seed application output from the natural language description using a text-to-image synthesis model.

Another example can include any of the above and/or below examples where the subsequent application outputs comprise video, audio, or haptic output.

Another example can include a computer-readable storage medium storing computer-readable instructions which, when executed by a hardware processing unit, cause the hardware processing unit to perform acts comprising obtaining a seed image, mapping the seed image to a seed image token using an encoder, inputting the seed image token to a transformer that has been trained to predict training sequences obtained from one or more executions of one or more applications, the training sequences including images output by the one more applications during the one or more executions and inputs to the one or more applications during the one or more executions, generating subsequent image tokens and subsequent input tokens with the transformer, and decoding the subsequent application image tokens with a decoder to obtain subsequent output images.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer system, comprising:
a processor; and
a memory coupled to the processor, the memory storing computer-readable instructions configured, when executed by the processor, to implement operations comprising:
receiving a first item;
outputting the first item;
inputting the first item to a generative model;
receiving from the generative model, in response to the first item, multiple candidate second items;
outputting each candidate second item;
receiving user input denoting a second item of the multiple candidate second items;
based on the user input, inputting the second item to the generative model;
receiving from the generative model, in response to the second item, a third item; and
outputting the third item.

2. The computer system of claim 1, wherein the first item forms part of a first item sequence inputted to the generative model, the first item sequence comprising multiple first items.

3. The computer system of claim 1, wherein multiple candidate second item sequences are received from the generative model, each comprising multiple second items, the second item forming part of a second item sequence of the multiple second candidate item sequences.

4. The computer system of claim 3, wherein the user input denotes one or some but not all second items of the second item sequence, wherein based on the user input said one or some but not all second items are inputted to the generative model.

5. The computer system of claim 3, wherein the user input denotes the second item and the first item;
wherein, based on the user input, the second item and the first item are inputted to the generative model, the third item being received in response thereto.

6. The computer system of claim 3, wherein the first item forms part of a first item sequence inputted to the generative model, the first item sequence comprising multiple first items;
wherein the user input denotes the second item of the second item sequence and:
the first item of the first item sequence, or
a further first item of the first item sequence;
wherein, based on the user input, the second item and the first item or the further first item are inputted to the generative model, the third item being received in response thereto.

7. The computer system of claim 3, wherein the user input denotes all candidate second items of the second candidate item sequence.

8. The computer system of claim 1, wherein outputting the first item comprises rendering the first item in a graphical user interface (GUI);
wherein outputting each candidate second item comprises rendering each candidate second item in the GUI with a first visual linking element that visually links each candidate second item with the first item.

9. The computer system of claim 8, wherein multiple candidate third items are received from the generative model in response to the second item, said operations comprising rendering each candidate third item in the GUI with a second visual linking element that visually links each candidate third item sequence with the second item.

10. The computer system of claim 1, wherein said operations comprise causing to be performed based on the third item an industrial machine action, a vehicle manipulation action, a security mitigation action, a machine repair or maintenance operation, or another physical action.

11. A computer-implemented method, comprising:
receiving from a generative model a generated item;
outputting the generated item;
receiving a manipulation input associated with the generated item;
creating a manipulated item based on the generated item and the manipulation input;
inputting the manipulated item to the generative model;
receiving from the generative model a further generated item in response to the manipulated first item; and
outputting the further generated item.

12. The method of claim 11, comprising:
receiving from the generative model a second generated item;
outputting the second generated item;
receiving a second manipulation input associated with the second generated item;
creating a second manipulated item based on the second generated item and the second image manipulation input;
wherein an item sequence comprising the manipulated item and the second manipulated item is inputted to the generative model, the further generated item received in response to the item sequence.

13. The method of claim 12, wherein the further generated item forms part of a further item sequence comprising multiple further generated items, the further item sequence received from the generative model in response to the item sequence.

14. The method of claim 12, wherein the generated item and the second generated item form part of a generated item sequence.

15. The method of claim 12, comprising:
receiving a seed item; and
inputting the seed item to the generative model, resulting in the generated item.

16. The method of claim 11, wherein the generated item is one of multiple candidate generated items received from the generative model, wherein each candidate generated item is outputted.

17. A computer-readable storage medium storing computer-readable instructions configured, when executed by a processor, to implement operations comprising:
receiving from a generative model a first generated item;
outputting the first generated item via a user interface (UI);
receiving a first user control input;
determining a first controller state based on the first user control input;
inputting to a generative model the first generated item and the first controller state;
receiving from the generative model a generated second item generated based on the first generated item and the first controller state; and
rendering the second generated item in the UI.

18. The computer-readable storage medium of claim 17, said operations comprising:
receiving a second user control input;
determining a second controller state based on the second user control input;
inputting to the generative model the second generated item and the second controller state;
receiving from the generative model a generated third content generated based on the second generated item and the second controller state; and
outputting the third generated item via the UI.

19. The computer-readable storage medium of claim 17, wherein the first user control input is received via a hardware game controller.

20. The computer-readable storage medium of claim 17, wherein the UI is a graphical user interface.
